(19) United States
(12) Patent Application Publication
(10) Pub. No.: US 2025/0351013 A1
(43) Pub. Date: Nov. 13, 2025

(54) SYSTEM AND METHOD FOR OPTIMIZED AUTHENTICATION IN COMMUNICATION NETWORKS

(71) Applicant: Charter Communications Operating, LLC, St. Louis, MO (US)

(72) Inventors: Umamaheswar A. Kakinada, Greenwood Village, CO (US); Imtiyaz Shaikh, Irving, TX (US)

(21) Appl. No.: 18/912,390

(22) Filed: Oct. 10, 2024

Related U.S. Application Data
(60) Provisional application No. 63/645,679, filed on May 10, 2024.

(51) Int. Cl. H04W 36/00; H04W 12/069; H04W 60/00; H04W 80/04

(52) U.S. Cl. CPC H04W 36/0033; H04W 12/069; H04W 60/005; H04W 80/04

(57) ABSTRACT

The disclosed method and system optimize IPSec connectivity and security association establishment in trusted and/or untrusted non-3GPP access scenarios, such as non-3GPP access with a Trusted Non-3GPP Gateway Function (TNGF) and/or Non-3GPP Interworking Function (N3IWF) in a 5G network architecture. The method involves initiating an Internet Key Exchange (IKE) protocol initiation communication from the User Equipment (UE) to the TNGF or N3IWF, which includes a MOBIKE_SUPPORT indicator to signal the UE's MOBIKE capability. The TNGF or N3IWF, in response to the MOBIKE_SUPPORT indicator, enables the use of MOBIKE to optimize an Internet Protocol Security (IPSec) session re-establishment when the UE moves to a different Trusted Non-3GPP Access Point (TNAP) connected to the same TNGF. The system includes the UE and TNGF configured to perform the method. The method and system minimize disruptions and latency during IPSec session re-establishment.

### PRIORITY AND RELATED APPLICATIONS

This application claims the benefit of priority to U.S. Patent Provisional Application No. 63/645,679, filed May 10, 2024, and entitled “System and Method for Authentication Optimization in Non-3GPP Access with TNGF,” which is incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present disclosure generally relates to the field of communication networks, and more specifically, to methods and systems for optimizing authentication in non-3GPP access with a Non-3GPP Gateway Function (NGF) in a 3GPP network architecture.

### BACKGROUND

In the field of telecommunications, the 3GPP network architecture, for example 5G networks architecture, has been developed to provide faster data speeds, lower latency, and more reliable connections compared to previous generations of mobile networks. Two key components of the 5G network architecture are Non-3GPP Gateway Function (NGF), which include the Trusted Non-3GPP Gateway Function (TNGF) and the Non-3GPP Interworking Function (N3IWF). These are responsible for managing and controlling the communication between User Equipment (UE) and the 5G network in trusted and untrusted non-3GPP access scenarios, respectively.

The UE refers to any device used directly by an end-user to communicate. This includes devices like mobile phones, tablets, and laptops equipped with mobile broadband adapters. The UE communicates with the network through Access Points (APs), which are devices that create a local area network (LAN) or wireless local area network (WLAN) to provide connectivity to the wider network. In trusted non-3GPP access, these APs may be directly managed by the network operator, while in untrusted non-3GPP access, they may be operated by third parties.

In the context of 5G networks, the UE may move between different APs while maintaining its connection to the network, regardless of whether these APs are part of trusted or untrusted non-3GPP access networks. This process is known as mobility and is a common occurrence in wireless networks due to the movement of users. When the UE moves from one AP to another, it may undergo a process known as re-authentication, which is a security measure to verify the identity of the UE and ensure the integrity of the communication.

The Internet Key Exchange (IKE) protocol, for example IKEv2, is a standard protocol used to set up a secure, authenticated communications channel between two parties. It uses a mechanism known as Security Associations (SAs) to establish the attributes of a secure connection, including the encryption and authentication methods to be used. The IKE protocol is often used in conjunction with the Internet Protocol Security (IPSec) protocol, which provides secure communication over IP networks through the use of cryptographic security services. These protocols are particularly important in untrusted non-3GPP access scenarios, where the communication path may traverse potentially insecure networks.

The Mobility and Multihoming Protocol (MOBIKE) is an extension to the IKE protocol that allows the IP addresses associated with IKE and IPSec SAs to change, which is useful in scenarios where a device moves between different network access points, whether in trusted or untrusted non-3GPP access environments. MOBIKE is specified in the Internet Engineering Task Force (IETF) Request for Comments (RFC) 4555, incorporated herein by reference in its entirety.

The Extensible Authentication Protocol (EAP) is a universal authentication framework frequently used in wireless networks and Point-to-Point connections. It provides a standardized interface for authentication methods and protocols, allowing the flexibility to use various authentication mechanisms. EAP can be employed in both trusted and untrusted non-3GPP access scenarios to facilitate secure authentication of UEs.

Despite these existing protocols and mechanisms, the process of re-authentication in both trusted and untrusted non-3GPP access environments within a 5G network architecture presents its own set of challenges and complexities. These challenges may vary depending on whether the UE is connecting through a trusted or untrusted non-3GPP access network. For instance, untrusted non-3GPP access may require additional security measures and protocol adaptations to ensure the same level of security and performance as trusted non-3GPP access. Furthermore, seamless mobility between trusted and untrusted non-3GPP access networks while maintaining session continuity and security poses additional challenges that have not been fully addressed in existing solutions.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

The present disclosure addresses the foregoing needs by providing, inter alia, apparatus and methods for enabling (or not enabling) mobility and multihoming protocol (MOBIKE) support in a non-3GPP (3rd Generation Partnership Project) network gateway function environment.

In one aspect, a method adapted for enabling mobility and multihoming protocol (MOBIKE) support in a non-3GPP (3rd Generation Partnership Project) network gateway function environment (e.g., a non-3GPP Gateway Function (NGF) or a non-3GPP interworking function (N3IWF)) is disclosed. In one embodiment, the method includes: initiating an exchange of data between a user equipment (UE) and an apparatus implemented for a network gateway function, the exchange of data comprising an exchange of first data indicative of whether the UE supports MOBIKE capability and second data indicative of whether the apparatus supports MOBIKE capability; utilizing the first and second data to determine whether to enable MOBIKE operations for at least one of the UE or the apparatus, thereby optimizing Internet Protocol Security (IPSec) session re-establishment based on a change in association of the UE from the first NAP to a second NAP in data communication with the apparatus; and based on the determination, enabling or not enabling the MOBIKE operations for the at least one of the UE or the apparatus.

In one variant, the initiating of the exchange occurs during a communication with a first non-3GPP access point (NAP) in data communication with an apparatus implemented for a network gateway function,

In another variant, the first NAP is a trusted Non-3GPP Access Point (TNAP); and the second NAP includes an untrusted non-3GPP access point (UNAP). In an alternative variant, the first NAP includes an untrusted non-3GPP access point (UNAP); and the second NAP includes a trusted Non-3GPP Access Point (TNAP).

In another variant, the apparatus includes a trusted non-3GPP Gateway Function (TNGF) or a non-3GPP interworking function (N3IWF).

In another variant, wherein the utilizing of the first and second data to determine whether to enable the MOBIKE operations includes determining to enable the MOBIKE operations for each of the UE and the apparatus only when the first and second data respectively indicate that both the UE and the apparatus support MOBIKE capability.

In another variant, the utilizing of the first and second data to determine whether to enable the MOBIKE operations includes determining to not enable the MOBIKE operations for the at least one of the UE or the apparatus based on at least one of the first data or the second data indicating that the at least one of the UE or the apparatus does not support the MOBIKE capability, respectively. In one implementation, the non-enablement of the MOBIKE operations for the at least one of the UE or the apparatus enables backwards compatibility without a need for changes to the at least one of the UE or the apparatus which does not support MOBIKE capability.

In another variant, the utilizing of the first and second data to determine whether to enable the MOBIKE operations includes utilizing one or more parameters to determine to not enable the MOBIKE operations for the at least one of the UE or the apparatus regardless of the at least one of the first or second data, respectively. In one implementation, the one or more parameters comprise at least one of: (i) one or more operational parameters, (ii) one or more policy parameters, or (iii) one or more configuration parameters.

In another variant, the first data includes at least one “MOBIKE_SUPPORT” indicator (e.g., per a MOBIKE protocol in accordance with RFC 4555). In another variant, the exchange of the data is part of an Internet Key Exchange (IKE) protocol initiation (IKE-INIT) communication.

In another aspect, a computerized apparatus implemented for a network gateway function (e.g., a non-3GPP gateway function (NGF) or a non-3GPP interworking function (N3IWF)) and data communication with a computerized client device, is disclosed. In one embodiment, the computerized apparatus includes: processor apparatus; interface apparatus in data communication with the processor apparatus and implemented for data communication with the computerized client device; and computerized logic in data communication with the processor apparatus.

In one variant, computerized logic is implemented to, when executed, cause the computerized apparatus to: receive first data originating from the computerized client device, the first data indicative of whether the computerized client device is mobility and multihoming protocol (MOBIKE) capable; generate second data for transmission to the computerized client device, the second data indicative of whether the computerized apparatus is MOBIKE capable; and determine, based on at least the first and second data, whether to enable one or more MOBIKE operations to optimize an Internet Protocol Security (IPSec) session re-establishment for the computerized client device in a handover operation from a first non-3GPP access point (NAP) to a second NAP in data communication with the computerized apparatus.

In one implementation, the receipt of the first communication and the transmission of the second communication are part of an Internet Key Exchange (IKE) protocol initiation (IKE-INIT).

In another implementation, the determination, based on at least the first and second data, of whether to enable the one or more MOBIKE operations is further based on third data relating to one or more of (i) operational data, (ii) policy data, or (iii) configuration data, such that MOBIKE is enabled based on the first and second data respectively indicating that the computerized client device and the non-3GPP gateway function apparatus are both MOBIKE capable unless at least one of the computerized client device or the non-3GPP gateway function apparatus determines not to enable the one or more MOBIKE operations based on the one or more of (i) the operational data, (ii) the policy data, or (iii) the configuration data.

In another aspect, a computerized user device implemented to communicate with a network having a plurality of access points and a network gateway function, is disclosed. In one embodiment, the computerized user device includes: processor apparatus; an interface apparatus in data communication with the processor apparatus and implemented to exchange data with an apparatus implemented for the network gateway function; and computerized logic in data communication with the processor apparatus.

In one variant, the computerized logic is implemented to, when executed by the processor apparatus, cause the computerized user device to: detect a move from a range within a first non-3GPP access point (NAP) to range within a second NAP connected to the apparatus; and based on the detection, initiate a mobility and multihoming protocol (MOBIKE) to update an existing Internet Protocol Security (IPSec) session to reflect a change in a point of attachment to a network.

In one implementation, the MOBIKE is implemented to cause a re-establishment, by the apparatus, of the IPSec session with the computerized user device over the second NAP using extant MOBIKE support, thereby maintaining a secure and continuous connection without need for full re-authentication with the second NAP.

In another implementation, the computerized logic is further implemented to, when executed by the processor apparatus, cause the computerized user device to: update an IP address of the computerized user device via use of a MOBIKE “UPDATE_SA_ADDRESSES” function to reflect the second NAP point of attachment to the network, wherein the maintenance of the IPSec session continuity is effected via processing of the updated IP address by the apparatus.

In another implementation, the detection includes a measurement of a signal strength to determine a connectivity level to the first NAP has diminished below a threshold level.

In another implementation, the initiation of the MOBIKE includes transmission of a MOBIKE “UPDATE_SA_ADDRESSES” message to the apparatus to inform the apparatus about a new point of attachment.

In another implementation, the re-establishment of the IPSec session is based on validation, by the apparatus, of the new point of attachment for the computerized user device. In another implementation, the re-establishment of the IPSec session includes maintenance of an IPSec Security Association (SA) without creating a new SA for the computerized user device.

In another implementation, the computerized logic is further implemented to, when executed by the processor apparatus, cause the computerized user device to: perform a mutual authentication process with the apparatus using existing credentials associated with the IPSec session prior to the re-establishment of the IPsec session.

In another aspect, a computer readable apparatus is disclosed. In one embodiment, comprising a non-transitory storage medium implemented to store one or more at least one computer program having a plurality of instructions. In an embodiment, the apparatus includes a program memory, HDD or SDD on a network gateway function (e.g., a non-3GPP gateway function (NGF) or a non-3GPP interworking function (N3IWF)) or user device (e.g., UE). In an embodiment, the apparatus includes a program memory or HDD or SDD on a separate network entity, such as a computerized controller device.

In one variant, the plurality of instructions are implemented to, when executed on a processing apparatus of a computerized client device (e.g., UE), cause the computerized client device to: detect a change of at least one of: (i) a first IP address to a second IP address, (ii) a first access network to a second access network, or (iii) a first point attachment to the first access network to a second point attachment to the second access network; utilize a mobility and multihoming protocol (MOBIKE) based on at least one attribute exchanged during an initial IPSec session establishment between the computerized client device and an apparatus implemented for a network gateway function; and transmit data representative of a notification to the apparatus to update a security association with respect to at least one of (i) the second IP address, (ii) the second access network, or (iii) the second point attachment.

In one implementation, the data representative of the notification is implemented to cause the apparatus to associate the at least one of (i) the second IP address, (ii) the second access network, or (iii) the second point attachment with outgoing encapsulating security payload (ESP) traffic for the UE.

In another implementation, latency is reduced in part by eliminating reestablishment at least one of Internet Key Exchange (IKE) and IPSec Security Associations (SAs).

In another implementation, the at least one attribute includes a “MOBIKE_SUPPORTED” attribute indicating MOBIKE compatibility by the computerized client device and a “MOBIKE_SUPPORTED” attribute indicating MOBIKE compatibility by the apparatus. In another implementation, the data representative of the notification includes a “UPDATE_SA_ADDRESSES” notification.

In another aspect, a method for maintaining a secure communication session in a wireless communication network is disclosed. In one embodiment, the method includes: establishing, by a user equipment (UE), a first secure communication session with a non-3GPP gateway function (NGF) via a first non-3GPP access point (NAP); disconnecting, by the UE, from the first NAP and connecting to a second NAP while maintaining the established secure communication session with the NGF; acquiring, by the UE, a new Internet Protocol (IP) address from the second NAP; and transmitting, by the UE, an update message to the NGF to associate the new IP address with the established secure communication session without re-establishing the secure communication session, where the update message causes the NGF to update security associations to associate the new IP address with a UE's prior secure communication session; and reusing, by the UE, the secure communication session with the NGF via the second NAP using the new IP address, wherein the secure communication session is maintained without requiring a full re-authentication process.

In one variant, the method further includes moving a communication link from the first NAP and connecting to the second NAP while maintaining the established secure communication session with the NGF.

In another variant, the update message includes a MOBIKE protocol “UPDATE_SA_ADDRESSES” notification. In yet another variant, the method further includes detecting, by the UE, the disconnection from the first NAP and a subsequent connection to the second NAP. In yet another variant, the secure communication session includes an Internet Protocol Security (IPSec) session. In yet another variant, the IPSec session is maintained by utilizing Mobility and Multihoming Protocol (MOBIKE) support. In yet another variant, the NGF updates the security associations without interrupting the data flow of the secure communication session.

In a further aspect, an integrated circuit (IC) apparatus is disclosed. In one embodiment, the IC apparatus includes one or more individual ICs or chips that are implemented to contain or implement computerized logic implemented to enable mobility and multihoming protocol (MOBIKE) support and related management functions within a device.

These and other aspects shall become apparent when considered in light of the disclosure provided herein.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a 5G network architecture with a Trusted Non-3GPP Access Network, in an embodiment.

FIG. 2A depicts the first part of a communication flow for authentication in trusted non-3GPP access, in an embodiment.

FIG. 2B shows the continuation of the communication flow from FIG. 2A, detailing further steps in the authentication process, in an embodiment.

FIG. 3 presents a modified communication flow, introducing the exchange of a MOBIKE_SUPPORTED indicator during the initial IPSec establishment, according to aspects of the present disclosure.

FIG. 4 outlines a communication flow for User Equipment re-authentication with a Trusted Non-3GPP Gateway Function, leveraging the MOBIKE functionality introduced in FIG. 3, according to aspects of the present disclosure.

FIG. 5 depicts a 5G network with a Trusted Non-3GPP Access Network, showing the User Equipment at two different locations and the associated communication interfaces, according to aspects of the present disclosure.

FIG. 6 illustrates a network system for UE mobility across trusted and untrusted non-3GPP access networks, in an embodiment.

FIG. 7 depicts a block diagram of a network for untrusted non-3GPP accesses in a 5G Core Network architecture, in an embodiment.

FIG. 8 shows the first part of an authentication process for untrusted non-3GPP access in a 5G network, in an embodiment.

FIG. 9 presents the continuation of the authentication process from FIG. 8, in an embodiment.

FIG. 10 illustrates a communication system for UE mobility across untrusted non-3GPP access networks, in an embodiment.

FIG. 11 depicts a sequence diagram of a UE re-authentication process with N3IWF in a communication system, in an embodiment.

FIG. 12 shows a system diagram of a control plane for untrusted non-3GPP access, in an embodiment.

FIG. 13 illustrates a control plane system for untrusted non-3GPP access after IPsec SA establishment, in an embodiment.

FIG. 14 depicts a system diagram of a control plane for user-plane establishment via N3IWF, in an embodiment.

FIG. 15 shows a system diagram of a user plane for untrusted non-3GPP access, in an embodiment.

FIG. 16 illustrates a system diagram of a control plane for trusted non-3GPP access before NWt connection establishment, in an embodiment.

FIG. 17 depicts a control plane system for trusted non-3GPP access after NWt connection establishment, in an embodiment.

FIG. 18 shows a block diagram of a control plane system for user-plane establishment via TNGF, in an embodiment.

FIG. 19 illustrates a system diagram of a user plane for trusted non-3GPP access, in an embodiment.

### DEFINITIONS

3GPP: Third Generation Partnership Project, a collaborative project that develops global standards for mobile telecommunications.

5G: The fifth generation of cellular network technology, providing faster speeds, lower latency, and more reliable connections than previous generations.

Access and Mobility Management Function (AMF): A key control-plane element in the 5G Core network responsible for registration, connection, reachability, and mobility management.

AUSF: Authentication Server Function, a network function in the 5G Core responsible for handling authentication requests and providing authentication vectors to the AMF. The AUSF may interact with the Unified Data Management (UDM) function to retrieve authentication data and may support various authentication methods, including 5G-AKA and EAP-based authentication.

Dynamic Host Configuration Protocol (DHCP): A network management protocol used to dynamically assign an IP address to any device, or node, on a network so it can communicate using IP.

Encapsulating Security Payload (ESP): A member of the IPsec protocol suite providing origin authenticity, integrity, and confidentiality protection of packets.

Extensible Authentication Protocol (EAP): An authentication framework frequently used in wireless networks and point-to-point connections, providing a generalized framework for various authentication methods.

Internet Key Exchange (IKE): A protocol used to set up a security association in the IPsec protocol suite, typically using X.509 certificates for authentication and a Diffie-Hellman key exchange to set up a shared session secret.

Internet Protocol Security (IPSec): A secure network protocol suite that authenticates and encrypts the packets of data to provide secure encrypted communication between two computers over an Internet Protocol network.

Mobility and Multihoming Protocol (MOBIKE): An extension to the Internet Key Exchange (IKEv2) standard, allowing the IP addresses associated with IKEv2 and IPsec security associations to change.

N1: Reference point between the UE and the AMF in a 5G System Architecture.

N2: Reference point between the (R)AN and the AMF in a 5G System Architecture.

N3: Reference point between the (R)AN and the UPF in a 5G System Architecture.

N4: Reference point between the SMF and the UPF in a 5G System Architecture.

N6: Reference point between the UPF and a Data Network in a 5G System Architecture.

N9: Reference point between two UPFs in a 5G System Architecture.

N11: Reference point between the AMF and the SMF in a 5G System Architecture.

N16: Reference point between two SMFs, (in roaming case between SMF in the visited network and the SMF in the home network) in a 5G System Architecture.

Non-3GPP Access Point (NAP): A wireless access point that provides connectivity to a non-3GPP network, such as Wi-Fi.

Non-3GPP Gateway Function (NGF): A function in the 5G core network that serves as a gateway for non-3GPP access, which can be either a Trusted Non-3GPP Gateway Function (TNGF) or a Non-3GPP Interworking Function (N3IWF).

Non-3GPP Interworking Function (N3IWF): A function that supports untrusted non-3GPP access to the 5G Core network.

NWt: Reference point between the UE and the TNGF. A secure NWt connection is established over this reference point, as specified in clause 4.12a.2.2 of TS 23.502. Non-Access-Stratum (NAS) messages between the UE and the AMF are transferred via this NWt connection.

NWu: Reference point between the UE and N3IWF for establishing secure tunnel(s) between the UE and N3IWF so that control-plane and user-plane exchanged between the UE and the 5G Core Network is transferred securely over untrusted non-3GPP access.

Packet Data Unit (PDU): A unit of data that is specified in a protocol of a given layer and that consists of protocol-control information and possibly user data of that layer.

Security Association (SA): The establishment of shared security attributes between two network entities to support secure communication.

Ta: A reference point between the TNAP and the TNGF, which is used to support an AAA interface in a 5G System Architecture.

Tn: A reference point between two TNGFs, which is used to facilitate UE mobility between different TNGFs (inter-TNGF mobility) in a 5G System Architecture.

Trusted Non-3GPP Access Network (TNAN): A non-3GPP access network that is considered trusted by the mobile network operator.

Trusted Non-3GPP Access Point (TNAP): A wireless access point that provides connectivity to a trusted non-3GPP network.

Trusted Non-3GPP Gateway Function (TNGF): A function in the 5G core network that serves as a gateway for trusted non-3GPP access.

User Equipment (UE): Any device used directly by an end-user to communicate, such as a smartphone, tablet, or IoT device.

User Plane Function (UPF): A function in the 5G core network responsible for packet routing and forwarding, packet inspection, and policy enforcement.

Y1: Reference point between the UE and the untrusted non-3GPP access (e.g. WLAN). This depends on the non-3GPP access technology and is outside the scope of 3GPP.

Y2: Reference point between the untrusted non-3GPP access and the N3IWF for the transport of NWu traffic.

Yt: Reference point between the UE and the TNAP in a 5G System Architecture.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

The present disclosure relates to a system and method for optimizing authentication in communication networks, particularly in non-3GPP access with a Trusted Non-3GPP Gateway Function (TNGF) in a 5G network architecture. In some aspects, the disclosed system and method address the challenge of frequent and disruptive full re-authentication when a device, or User Equipment (UE), moves from one Access Point (AP) to another under the same TNGF.

In some cases, the disclosed system and method involve the establishment of a layer-2 connection, initiation of an Extensible Authentication Protocol (EAP) procedure, execution of an EAP-5G procedure, and establishment of a security association to protect all subsequent traffic. The process may diverge based on whether the TNGF is appropriate for the selected network slice.

More particularly, the disclosed system and method propose the optimization of the Internet Protocol Security (IPSec) session re-establishment using the Mobility and Multihoming Protocol (MOBIKE) as per RFC 4555. This approach may avoid the expensive and disruptive process of full IPSec re-establishment, minimize latency, and reduce additional processing at the device and network. The solution may be backward compatible, require minimum functional changes, and can be selectively enabled or disabled based on the device's profile, subscription status, and security status.

In some aspects, the disclosed system and method leverage existing protocol extensions to provide new functionality, minimize disruptions to user traffic, and enhance user experience. The benefits may include quick re-authentication, minimized network traffic, reduced load on core network functions, and enhanced user experience.

The teachings of “IETF RFC 4301 Security Architecture for the Internet Protocol,” which describes the framework for providing security services for traffic at the IP layer, are hereby incorporated by reference in their entirety.

The teachings of “IETF RFC 4306 Internet Key Exchange (IKEv2) Protocol,” which specifies the protocol for establishing mutual authentication and a secure association between two parties, are hereby incorporated by reference in their full extent.

The teachings of “IETF RFC 4555 IKEv2 Mobility and Multihoming Protocol (MOBIKE),” which details the protocol enhancements for supporting mobility and multihoming capabilities in the Internet Key Exchange (IKEv2) protocol, are hereby incorporated by reference in their totality.

The teachings of “3GPP TS 23.501 System architecture for the 5G System,” which outlines the system architecture for the 5G network, including functions, services, and interfaces, are hereby incorporated by reference in their complete form.

The teachings of “3GPP TS 23.502 Services and System Aspects Procedures for the 5G System,” which describes the procedures for the operation of the 5G system, including session management, mobility handling, and authentication, are hereby incorporated by reference in their complete form.

The teachings of “3GPP TS 33.501 Security architecture and procedures for the 5G System,” which provides a detailed description of the security framework, including the architecture and procedures for the 5G system, are hereby incorporated by reference in their complete form.

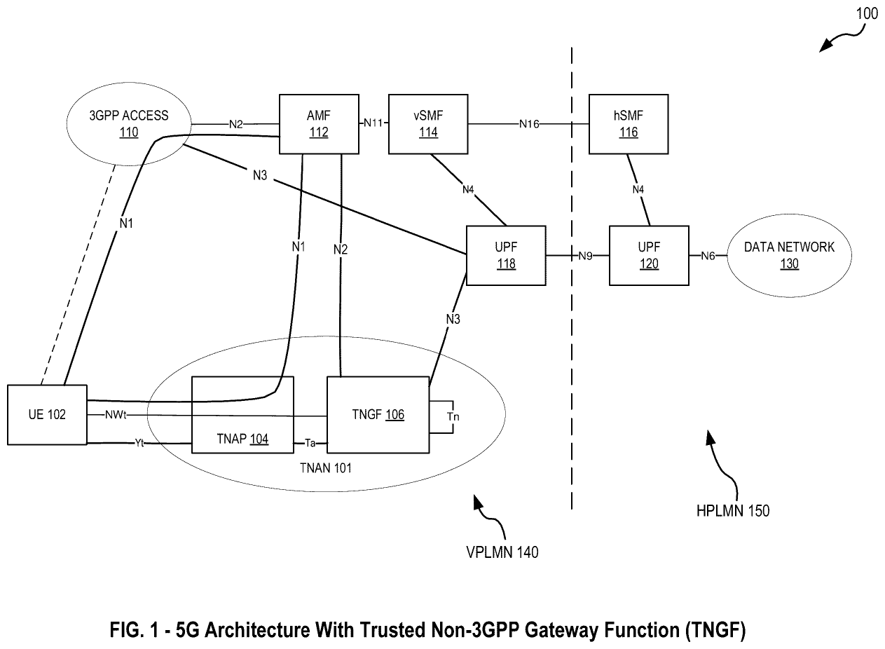

Referring to FIG. 1, a system 100 of a 5G network architecture connected to a Trusted Non-3GPP Network is depicted. The system 100 includes a User Equipment (UE) 102, which may be any type of mobile device such as, but not limited to, a smartphone, smart device, communication enabled vehicle, communication enabled drone, tablet, laptop, or IoT device. The UE 102 communicates via a Yt interface with a Trusted Non-3GPP Access Point (TNAP) 104. The TNAP 104 may be a wireless access point that provides connectivity to the UE 102 in a non-3GPP network, such as a WLAN network, for example a Wi-Fi network.

The TNAP 104 is in communication, via a Ta interface, with a Trusted Non-3GPP Gateway Function (TNGF) 106. The TNAP 104 and TNGF 106 form part of a Trusted Non-3GPP Access Network (TNAN) 101. The TNGF 106 serves as a gateway between the non-3GPP network and the 5G network, facilitating the transfer of data and control information between the UE 102 and the 5G network.

The UE 102 is also in communication with the TNGF 106 via an NWt interface. This interface may be used for the exchange of data and control information between the UE 102 and the TNGF 106. The UE 102 also communicates with an Access and Mobility Management Function (AMF) 112 via a first N1 interface and through a 3GPP access 110 via a second N1 interface. The AMF 112 is a core network function in the 5G network that manages the mobility and access of the UE 102.

The TNGF 106 also utilizes an N3 interface to communicate with a User Plane Function (UPF) 118. The UPF 118 is responsible for handling user data traffic in the 5G network. The TNGF 106 is also shown with a Tn interface for interfacing with other TNGFs, enabling communication and coordination between different TNGFs in the network.

The TNGF 106 interfaces, via an N2 interface, with the AMF 112 of the 3GPP Network. The AMF 112 connects, via an N11 interface, to a Visited Session Management Function (vSMF) 114, which itself interfaces, via an N16 interface, with a Home Session Management Function (hSMF) 116. The vSMF 114 and hSMF 116 are responsible for managing the sessions of the UE 102 in the visited and home networks, respectively.

The UPF 118 is in communication, via an N4 interface, with the vSMF 114, and another UPF 120 is in communication, via another N4 interface, with the hSMF 116. The UPF 118 and UPF 120 communicate via an N9 interface, and the UPF 120 utilizes an N6 interface to connect with a data network 130. The data network 130 may be any type of network, such as the internet, that provides data services to the UE 102. For sake of clarity and to ease explanation not all components and interfaces are shown.

The UPF 118 also communicates with the 3GPP access 110 via an N3 interface. The 3GPP access 110 communicates with the AMF 112 via an N2 interface, facilitating the exchange of control information between the 3GPP access 110 and the AMF 112.

The network architecture of system 100 is divided into the Visited Public Land Mobile Network 140 and the Home Public Land Mobile Network 150. This division indicates the network's capability to manage communications across different mobile network domains, allowing the UE 102 to maintain connectivity and services as it moves between different networks.

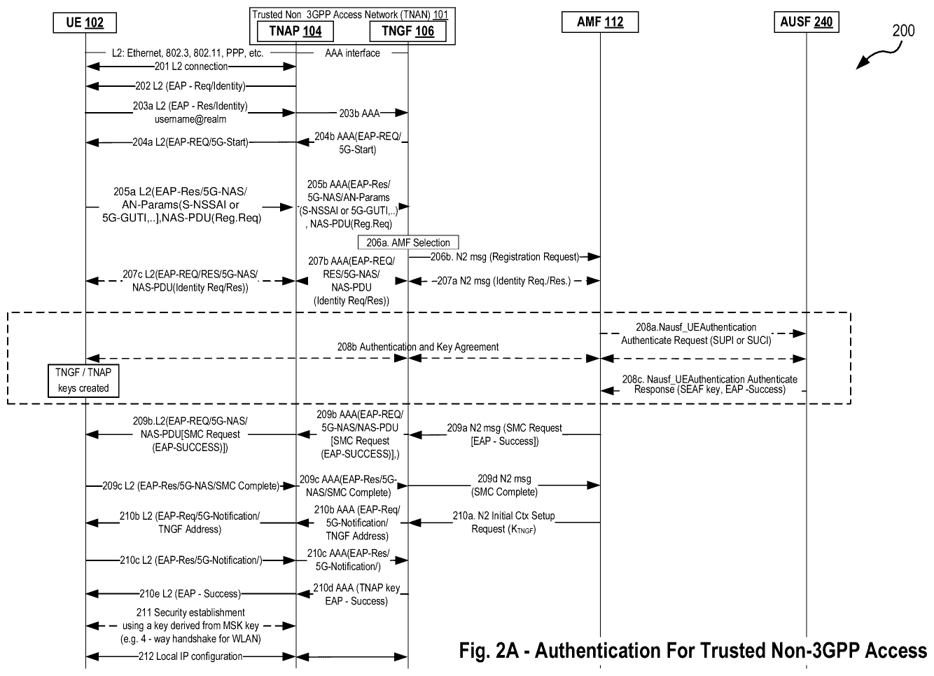

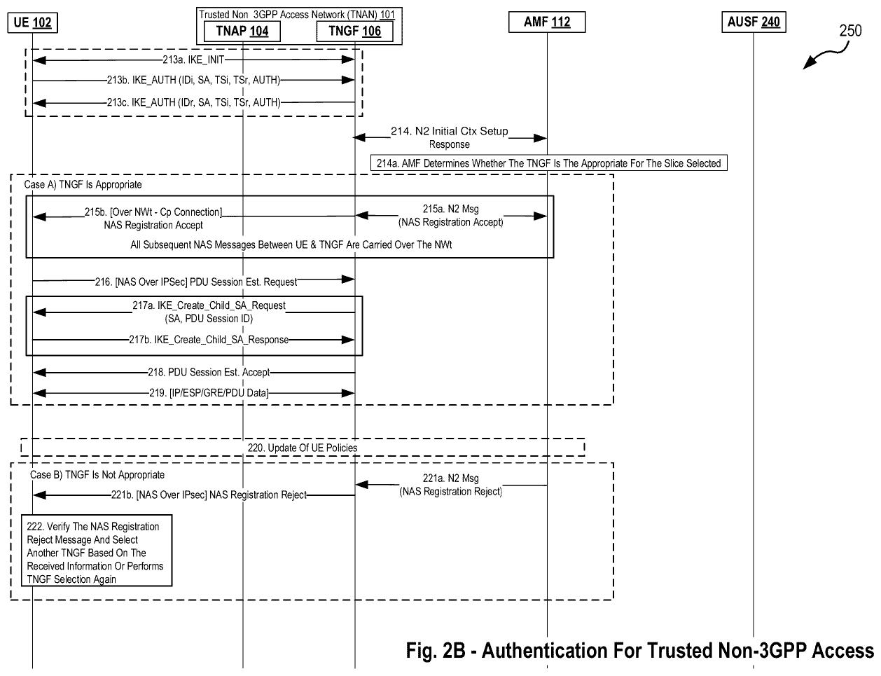

Referring to FIG. 2A, a communication flow 200 for authentication for trusted non-3GPP access devices is depicted. The User Equipment (UE 102) initiates the process by establishing a connection with a Trusted Non-3GPP Access Point (TNAP 104) via steps 201-203a. The TNAP 104 communicates with the Trusted Non-3GPP Gateway Function (TNGF 106). The TNGF 106 interacts with the Access and Mobility Management Function (AMF 112), which in turn communicates with an Authentication Server Function (240).

An L2 connection is established in step 201. Communication flow 200 illustrates the exchange of various Extensible Authentication Protocol (EAP) messages. These include an EAP Request Identity 202, an EAP Response Identity with Username Email 203a, which communicates this information with the TNGF via the AAA interface at 203b, which replies with an AAA EAP-REQ/5G-Start 204b, and an L2 EAP-REQ/5G-Start 204a. UE 102 then transmits a 205a L2 (e.g., EAP-Res, 5G-NAS, AN-Params (S-NSSAI, 5G-GUTI, etc.), NAS-PDU (e.g., “Registration Request”)) message to TNAP 104, which forwards that 205b to TNGF 106.

The process includes an AMF Selection 206a and AMF registration request 206b and an AMF Identity request response 207a each over the N2 interface. This leads to further EAP exchanges such as an EAP Request 5G NAS for NAS PDU Identity Request 207b and 207c.

A Nausf_UEAuthentication 208a message is sent, then an Authentication and Key Agreement 208b is performed, followed by an Nausf_UEAuthentication Authenticate Response (SEAF key, EAP-Success) 208c. Part of this process establishes a TNGF/TNAP key.

The flowchart also shows the establishment of security through an SMC Request [EAP-Success] 209a, and (EAP-REQ/5G-NAS/NAS-PDU [SMC Request (EAP-SUCCESS)],) Requests 209b (over the AAA and L2 connections), Responses 209c, and SMC Complete 209d. Subsequent N2 Initial Context Setup Request 210a and EAP-Req/5G-Notification/TNGF Address 210b's (over the AAA and L2 connections) and L2 and AAA (EAP-Res/5G-Notification/) 210c's, ending with a TNAP key EAP—Success 210d and EAP—Success 210e. The process concludes with a Security Establishment using a key derived from MSK key 211 and an IP Configuration 212, ensuring a secure and authenticated connection between User Equipment 102 and the network.

FIG. 2B shows a communication flow 250, which is a continuation of the communication flow 200 from FIG. 2A, starting at step 213a. In this step, the User Equipment (UE 102) initiates an Internet Key Exchange (IKE) protocol initiation (IKE-INIT) exchange with the Trusted Non-3GPP Gateway Function (TNGF 106). Subsequently, the UE 102 initiates an IKE_AUTH exchange 213A and 213b, which includes, for example, IDi, SA, TSi, TSr, and AUTH. The common K_{TIPSe} is used for mutual authentication. The K_{TIPSec}, which is derived as specified in Annex A.22, is used for mutual authentication. NULL encryption is negotiated as specified in RFC 2410 [81]. After step 213c, an IPsec Security Association (SA) is established between the UE 102 and the TNGF 106 (i.e., a NWt connection) and it is used to transfer all subsequent NAS messages. This IPsec SA may not apply encryption but can apply integrity protection.

In step 214, after the NWtp connection is successfully established, the TNGF 106 responds to the Access and Mobility Management Function (AMF 112) with an N2 Initial Context Setup Response message. In step 214a, the AMF 112 may determine whether the TNGF 106 is appropriate for the slice selected as defined in clause 4.12.2.2 of TS 23.502[8]. If the TNGF 106 is compatible with the selected slice, then the process proceeds with steps 215 to step 219. Otherwise, the AMF 112 proceeds with step 220 to step 222, and steps 215 to step 219 are skipped.

In Case A), the NAS Registration Accept message is sent by the AMF 112 and is forwarded to the UE 102 via the established NWt connection in step 215. In steps 216 to 218, the UE 102 initiates a PDU session establishment. This is carried out exactly as specified in TS 23.502 [8] clause 4.12a.5. The TNGF 106 may establish one or more IPSec child SAs per PDU session. In step 219, user plane data for the established PDU session is transported between the UE 102 and the TNGF 106 inside the established IPSec child SA.

In Case B), the AMF 112 may trigger the UE 102 policy update procedure and update the UE 102 policy as defined in step 17 and step 18 in clause 4.12a.2.2 of TS 23.502 [8] in step 220. In step 221, the AMF 112 sends a Registration Reject message via the TNGF 106 to the UE 102 as defined in step 19 to step 21 in clause 4.12a.2.2 of TS 23.502[8]. The Registration Reject message is ciphered and integrity protected. In step 222, the UE 102 deciphers and verifies the integrity of the Registration Reject message. If verification is successful, then the UE 102 proceeds with step 21 in clause 4.12.2.2 of TS 23.502[8], and sends a Registration request message to the AMF 112 via a new selected TNGF 106.

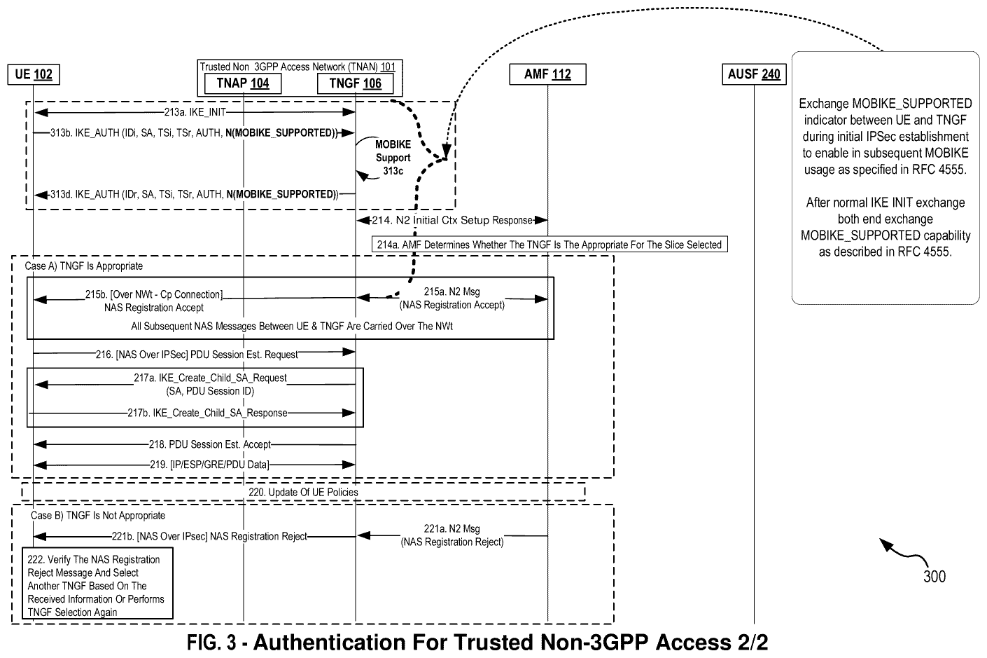

Referring to FIG. 3, a communication flow 300 is depicted, which is similar to communication flow 250 of FIG. 2B, with differences being steps 213b-c of communication flow 250 replaced by new steps 313b-d.

In step 313b, the User Equipment (UE 102) transmits amended Internet Key Exchange (IKE) protocol initiation (IKE-INIT) communication, the amendment including an additional MOBIKE_SUPPORTED indicator. This indicator, shown as “N(MOBIKE_SUPPORTED)” as defined by the “IKEv2 Mobility and Multihoming Protocol (MOBIKE)” specification, IETF RFC 4555 of June 2006, is sent from the UE 102 to the Trusted Non-3GPP Gateway Function (TNGF 106). The MOBIKE_SUPPORTED indicator signals to the TNGF 106 that the UE 102 supports MOBIKE.

In new step 313c, the TNGF 106 processes the received MOBIKE_SUPPORTED indicator and determines if it supports MOBIKE. If TNGF 106 does not support MOBIKE, it will ignore this indicator and proceed shown in communication flow 250. However, if the TNGF 106 does support MOBIKE and can provide MOBIKE services to the UE 102, the communication flow 300 moves to step 313d.

In step 313d, the TNGF 106 replies to the UE 102 with a new IKE_AUTH that includes a MOBIKE_SUPPORTED indicator. This indicator, also as defined by the “IKEv2 Mobility and Multihoming Protocol (MOBIKE)”, signals to the UE 102 that the TNGF 106 supports MOBIKE.

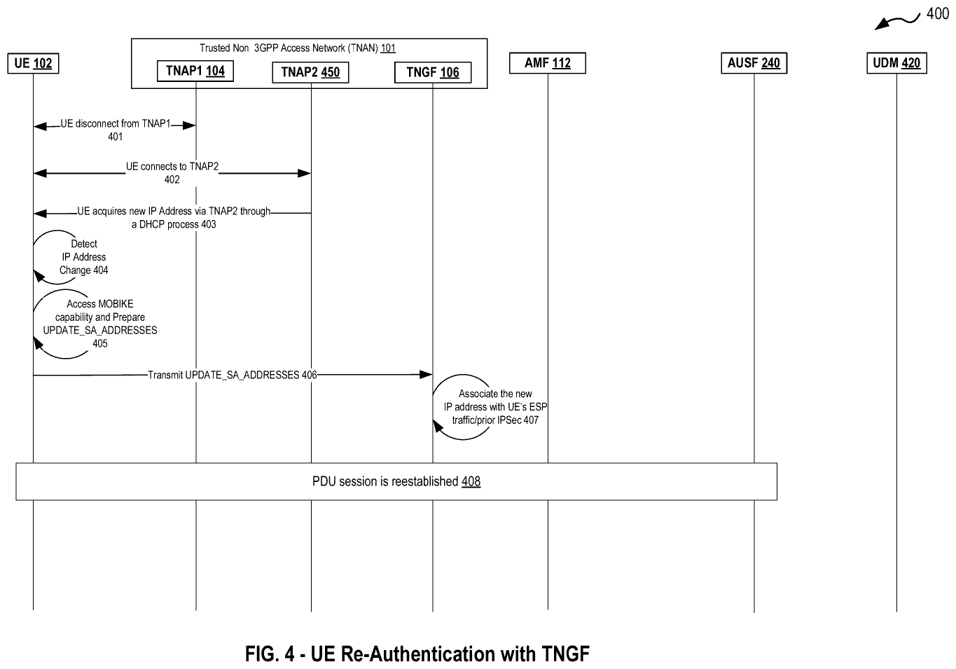

By adding the MOBIKE functionality at this initial setup point, the systems and methods discussed here provide for future optimization and latency reduction when the UE 102 moves from a first Trusted Non-3GPP Access Point (TNAP) 104 to a second TNAP 450, as discussed more in FIG. 4. This optimization may reduce latency, avoid a full IPSec reestablishment process, and minimize disruptions to user plane traffic and end user experience.

Referring to FIG. 4, a communication flow 400 is depicted, illustrating the process of User Equipment (UE 102) re-authentication with a Trusted Non-3GPP Gateway Function (TNGF 106) via a new Trusted Non-3GPP Access Point (TNAP 450).

In step 401, the UE 102 loses its connection with first TNAP 104. Following this, in step 402, the UE 102 connects to a second TNAP 450. This transition from one TNAP to another may occur when the UE 102 moves within the coverage area of the Trusted Non-3GPP Access Network (TNAN 101).

In step 403, the UE 102 acquires a new IP address, e.g., via a Dynamic Host Configuration Protocol (DHCP) process from the second TNAP 450. This new IP address is associated with the second TNAP 450 and is different from the IP address that the UE 102 had when it was connected to the first TNAP 104.

In step 404, the UE 102 detects the change in its IP address. This detection may be triggered by the DHCP process in step 403. Upon detecting the IP address change, the UE 102 triggers a process to access its MOBIKE capability and prepare an “UPDATE_SA_ADDRESSES” notification in step 405. This notification is used to update one or more Security Association (SA) addresses associated with the IPSec session between the UE 102 and the TNGF 106.

In step 406, the UE 102 transmits the UPDATE_SA_ADDRESSES notification to the TNGF 106 via the second TNAP 450. This transmission informs the TNGF 106 of the new IP address of the UE 102 and requests the TNGF 106 to update the SA addresses accordingly.

In step 407, the TNGF 106 associates the new IP address of the UE 102 with the UE's prior Encapsulating Security Payload (ESP) traffic and prior IPSec. This association allows the TNGF 106 to continue the IPSec session with the UE 102 using the new IP address, without requiring a full re-establishment of the IPSec session.

In step 408, the Packet Data Unit (PDU) session is reestablished between the UE 102 and the TNGF 106. This reestablishment of the PDU session allows the UE 102 to continue its data communication with the TNGF 106 via the second TNAP 450.

In some aspects, the method involves using the MOBIKE_SUPPORT indicator to enable MOBIKE operations for optimizing the Internet Protocol Security (IPSec) session re-establishment when the UE 102 moves to a second TNAP 450 connected to the same TNGF 106. This optimization may reduce latency, avoid a full IPSec reestablishment process, and minimize disruptions to user plane traffic and end user experience.

In some cases, the method involves updating the IP address of the UE 102 using the MOBIKE “UPDATE_SA_ADDRESSES” function to reflect the new point of attachment to the network. The TNGF 106 processes the updated IP address to maintain the IPSec session continuity.

In some aspects, the method involves detecting, at the UE 102, a move from a first TNAP 104 to a second TNAP 450 connected to the same TNGF 106. This detection may trigger the process of accessing the MOBIKE capability and preparing the “UPDATE_SA_ADDRESSES” notification.

In some cases, the method involves re-establishing, by the TNGF 106, the IPSec session with the UE 102 over the second TNAP 450 using the previously established MOBIKE support. This re-establishment maintains a secure and continuous connection without the full re-authentication.

In some aspects, the method further involves updating the IP address of the UE 102 using the MOBIKE “UPDATE_SA_ADDRESSES” function to reflect the new point of attachment to the network. The TNGF 106 processes the updated IP address to maintain the IPSec session continuity.

In some aspects, UE 102 may detect a change in its IP address, as depicted in step 404 of FIG. 4. This detection may be triggered by the DHCP process in step 403, where the UE 102 acquires a new IP address via a DHCP process from the second TNAP 450. The new IP address is associated with the second TNAP 450 and is different from the IP address that the UE 102 had when it was connected to the first TNAP 104.

Upon detecting the IP address change, the UE 102 may trigger a process to access its MOBIKE capability and prepare an “UPDATE_SA_ADDRESSES” notification in step 405. This notification is used to update one or more Security Association (SA) addresses associated with the IPSec session between the UE 102 and the TNGF 106.

In some cases, the UE 102 may transmit the UPDATE_SA_ADDRESSES notification to the TNGF 106 via the second TNAP 450, as depicted in step 406. This transmission informs the TNGF 106 of the new IP address of the UE 102 and requests the TNGF 106 to update the SA addresses accordingly.

In some aspects, the TNGF 106 may receive the UPDATE_SA_ADDRESSES notification from the UE 102, as depicted in step 406. Upon receiving the notification, the TNGF 106 may process the updated IP address and associate it with the UE's prior Encapsulating Security Payload (ESP) traffic and prior IPSec, as shown in step 407. This association allows the TNGF 106 to continue the IPSec session with the UE 102 using the new IP address, without requiring a full re-establishment of the IPSec session.

In some cases, the method may involve reducing latency by eliminating reestablishment of Internet Key Exchange (IKE) and IPSec Security Associations (SAs). This reduction in latency may be achieved by utilizing the MOBIKE protocol to update the existing IPSec session to reflect the change in the point of attachment to the network, thereby avoiding a full IPSec reestablishment process. This optimization may minimize disruptions to user plane traffic and enhance end user experience.

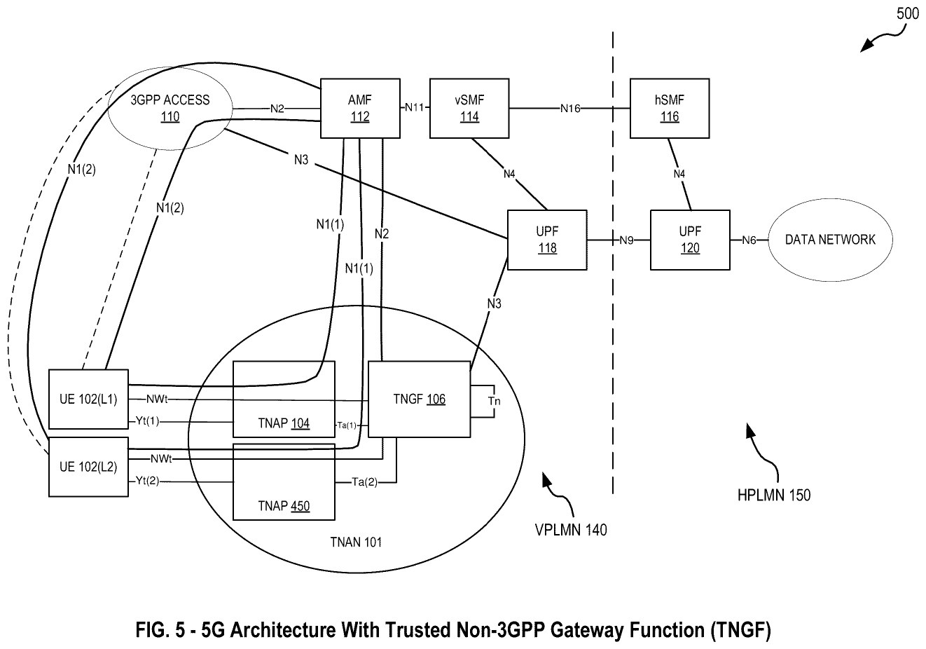

Referring to FIG. 5, a communication network/system 500 is depicted, which includes a 5G network and a Trusted Non-3GPP Access Network (TNAN) 101. The network/system 500 shows components and interconnections of a 5G network with a Trusted Non-3GPP Gateway Function (TNGF 106). The network/system 500 is similar to the system/network 100 described earlier, with the focus here being on the differences.

In the depicted network/system 500, a User Equipment (UE 102) is shown at a first location, represented as UE 102(L1), in communication with a first Trusted Non-3GPP Access Point (TNAP 104). At a later time, the UE 102 is shown at a second location, represented by UE 102(L2), where it is in communication with a second TNAP, represented as TNAP 450. Both TNAP 104 and TNAP 450 are in communication with the same TNGF 106. It will be understood that many TNAPs may be in communication with the TNGF 106 and each time the UE 102 associates with a new TNAP, the systems and methods disclosed herein may be beneficially applied.

The UE 102(L1) is shown with communication interfaces N1(1), NWt, and Yt(1), all known and described in the 3GPP specifications and system 100 of FIG. 1. The UE 102(L2) is shown with communication interfaces N1(1), NWt, Yt(2), and N1(2). By way of the present systems and methods, when the UE 102 disconnects from the TNAP 104, it drops the Yt(1) interface and when the UE 102 connects to the TNAP 450, it establishes the Yt(2) interface. The present systems and methods allow for the reuse of the prior NWt and N1(1) interfaces on the TNAN 101, thus beneficially avoiding the process to instantiate reconnections for those interfaces. Instead, the TNGF 106 may update the IP addresses associated with each security association (SA) connected to the UE 102. It will be understood that one UE may have many SAs, thus the benefits of the present systems and methods have a great impact the more SAs a UE has associated with it. The Ta(1) and Ta(2) interfaces are TNAP to TNGF interfaces and are unaffected by the present systems and methods.

It is noted that the N1(2) interface is unaffected by the present systems and methods as that is a 3GPP interface and therefore remains intact.

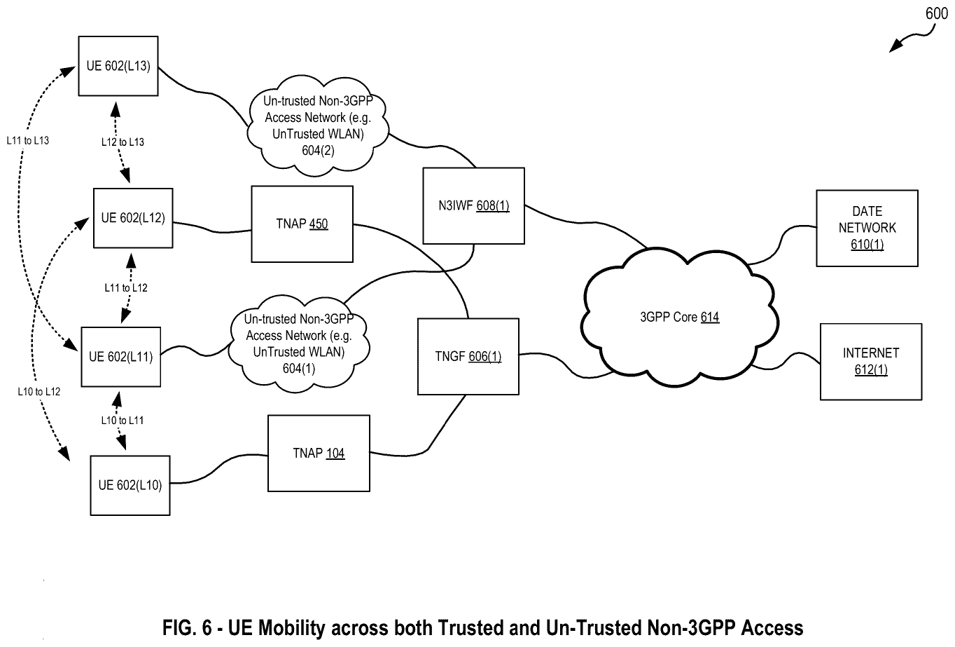

FIG. 6 shows a network system 600 designed for UE mobility across and between both trusted and un-trusted non-3GPP access networks. System 600 is shown to include several components interconnected to facilitate communication between user equipment 602 and various network elements.

The untrusted non-3GPP access network 604 is shown in two instances, labeled as 604(1) and 604(2), representing different untrusted WLAN networks. These networks provide connectivity for the user equipment 602 at different locations.

The user equipment 602 is depicted at multiple locations (L10, L11, L12, L13), representing its mobility within the network. Each instance of user equipment 602 is connected to either an untrusted non-3GPP access network 604 or a trusted non-3GPP access point (TNAP) 104, 450. System 600 also shows movement between untrusted non-3GPP access networks, between TNAPs, and between one of the untrusted non-3GPP access networks and one of the TNAPs.

The trusted non-3GPP gateway function 606 and the non-3GPP interworking function 608 serve as intermediaries between the TNAPs 104, 450 and the 3GPP core 614. The trusted non-3GPP gateway functions 606(1) is connected to trusted non-3GPP access points (TNAPs) 104 and 450, while the non-3GPP interworking function 608 interfaces with the untrusted non-3GPP access networks 604(1) and 604(2).

The 3GPP core 614 represents the core network infrastructure. It is connected to the trusted non-3GPP gateway function 606 and the non-3GPP interworking function 608, enabling communication with the user equipment 602 through various access networks.

The data network 610 and the internet 612 are shown connected to the 3GPP core 614, representing the endpoints for user data traffic and internet access respectively.

The network system 600 illustrates the path of communication from the user equipment 602 through various access points and gateway functions to the 3GPP core 614. Dotted lines between different instances of the user equipment 602 indicate the mobility path, showing transitions between different locations (L10 to L11, L11 to L12, L12 to L13, L10 to L12, and L11 to L13).

This architecture allows the user equipment 602 to maintain connectivity as it moves between different trusted and untrusted non-3GPP access points, providing seamless mobility across heterogeneous network environments and homogeneous network environments.

In some cases, while in a given access network (trusted or untrusted non-3GPP access) at power-up or at first connection to a network, the UE may establish an initial connection using conventional access-specific procedures. During this initial connection establishment, the UE and the network gateway function (such as TNGF for trusted access or N3IWF for untrusted access) may exchange MOBIKE_SUPPORTED indicators as part of their IKE_AUTH messages. This exchange signals that both entities are capable of supporting MOBIKE and allows them to store this information for future use.

Later, when the UE moves to a different type of non-3GPP access (i.e., from trusted to untrusted or vice-versa, from trusted to trusted, and from untrusted to untrusted), it may preserve the context information before establishing a new connection in an access-specific manner. This context information may include the MOBIKE support status, as well as other security-related parameters.

MOBIKE facilitates this process by allowing the UE to maintain and update its IPSec security associations (SAs) without full re-establishment. When the UE detects a change in its network attachment, it can initiate the UPDATE_SA_ADDRESSES procedure as defined in RFC 4555. This procedure allows the UE to inform the gateway function of its new IP address while preserving the existing security context.

For instance, when moving from a trusted to an untrusted network (or vice versa), the UE may use MOBIKE to update its IP address with the new N3IWF (or TNGF) while reestablishing the security associations established with one or more previous N3IWF (or TNGF). In some aspects, when a UE 602(L11) moves from untrusted non-3GPP access network 604(1) to a trusted non-3GPP access point TNAP 450, representing a transition from location L11 to L12, the UE may employ MOBIKE to facilitate the transition. As the UE 602(L12) connects to TNAP 450, it may use MOBIKE to update its IP address with TNGF 606, which UE 602 was previously associated with when connected to TNAP 104. The UE 602(L12) may leverage security context information from a previous connection to TNAP 104 when it was at Location L10 at UE 602(L10), if available. This process may allow the UE to maintain secure connections across different types of non-3GPP access networks, potentially reducing latency and signaling overhead during the transition from L11 to L12.

Similarly, when transitioning between two trusted, MOBIKE enables the UE to update its IP address with the same gateway function without full re-authentication. In some aspects, when a UE 602(L10) moves from a first trusted non-3GPP access point TNAP 104 to a second trusted non-3GPP access point TNAP 450, representing a transition from location L10 to L12, the UE may employ MOBIKE to facilitate the transition. As the UE 602(L12) connects to TNAP 450, it may use MOBIKE to update its IP address with the same TNGF 606 that it was previously associated with when connected to TNAP 104. The UE 602(L12) may maintain the existing security associations established with TNGF 606 during its previous connection to TNAP 104. This process may allow the UE to update its IP address with the same gateway function without requiring full re-authentication, potentially reducing latency and signaling overhead during the transition from L10 to L12 within the trusted non-3GPP access network.

Similarly, when transitioning between two untrusted networks, MOBIKE enables the UE to update its IP address with the same gateway function without full re-authentication. In some aspects, when a UE 602(L11) moves from a first untrusted non-3GPP access network 604(1) to a second untrusted non-3GPP access network 604(2), representing a transition from location L11 to L13, the UE may employ MOBIKE to facilitate the transition. As the UE 602(L13) connects to 604(2), it may use MOBIKE to update its IP address with the same N3IWF 608 that it was previously associated with when connected to 604(1). The UE 602(L13) may maintain the existing security associations established with N3IWF 608 during its previous connection to 604(1). This process may allow the UE to update its IP address with the same gateway function without requiring full re-authentication, potentially reducing latency and signaling overhead during the transition from L11 to L13 within the untrusted non-3GPP access networks.

The gateway function, upon receiving the UPDATE_SA_ADDRESSES message, can verify the UE's identity using the preserved context information and update the security associations with the UE's new IP address. This process may significantly reduce the latency and signaling overhead associated with re-establishing the entire IPSec connection.

By utilizing MOBIKE in this manner, the system can provide seamless mobility across different types of non-3GPP access networks, potentially reducing connection interruptions and enhancing overall network performance. The duration for which the context is preserved in the UE and network gateway functions may be determined by operator policy and discretion. During its mobility, when the UE happens to land in an access network for which it has a preserved context and satisfies other operator-specified constraints (e.g., context information is not aged out), the UE may use the previously saved context information to revive the IPSec connection and security associations (SAs) following access-specific procedures.

This approach may enable efficient handovers between non-3GPP access networks, potentially reducing latency and improving the user experience during mobility events.

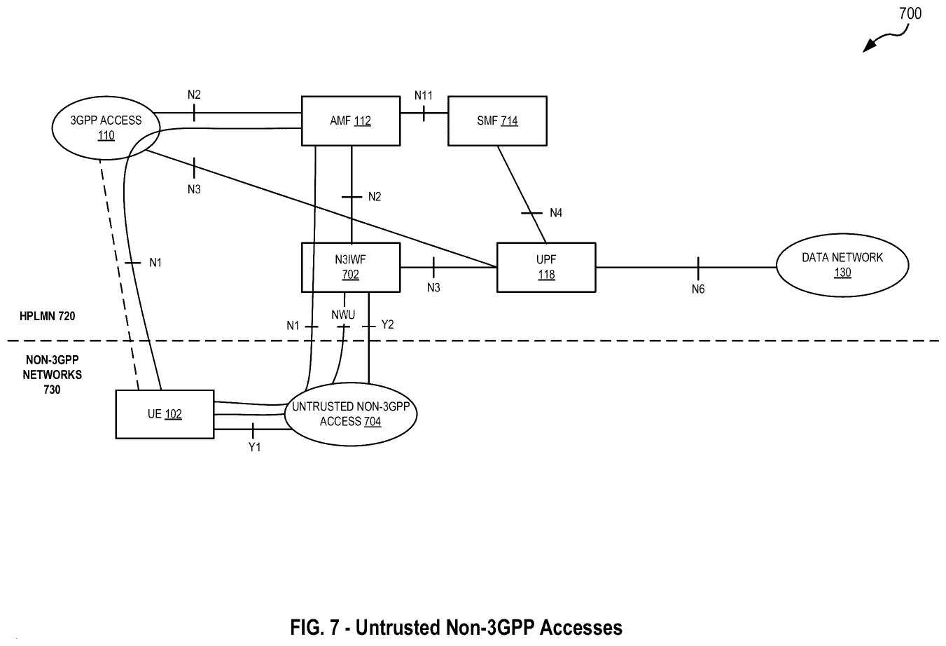

FIG. 7 shows a block diagram of a network 700 for untrusted non-3GPP accesses in a 5G Core Network architecture. The network 700 is shown to include several interconnected components to facilitate communication between user equipment and the core network.

The present systems and methods are applicable to untrusted non-3GPP access as well as trust networks. It is more relevant for untrusted non-3GPP access, as the access network is not likely under an Operator control. When UE moves between different APs in untrusted access it is likely to result in local IP address changes necessitating an IPSec all security association reestablishment.

The network 700 includes a 3GPP access 110 connected to an Access & Mobility Management Function (AMF) 112. The AMF 112 is further connected to a Session Management Function (SMF) 714 through an N11 interface.

A User Equipment (UE) 102 is connected to an untrusted non-3GPP access 704, which is part of the non-3GPP networks 730. The UE 102 communicates with the untrusted non-3GPP access 704 through a Y1 interface.

The network 700 includes a non-3GPP Interworking Function (N3IWF) 702 that serves as an intermediary between the untrusted non-3GPP access 704 and the core network components. The N3IWF 702 is connected to the AMF 112 via an N2 interface and to a User plane Function (UPF) 118 through an N3 interface.

The UPF 118 is connected to the SMF 714 via an N4 interface and to a data network 130 through an N6 interface. The UPF 118 also has a connection to the 3GPP access 110 via an N3 interface.

The network 700 is divided into two domains: the Home Public Land Mobile Network (HPLMN) 720 and the non-3GPP networks 730, separated by a dashed line in the diagram.

This architecture allows for communication between the UE 102 and the core network through untrusted non-3GPP access, providing flexibility in network connectivity. The N3IWF 702 facilitates the integration of untrusted non-3GPP access with the 5G core network, enabling secure communication for the UE 102.

In some aspects, the network 700 may be implemented according to the 3GPP 23. 501 specification, particularly as described in FIG. 4.2.8.2.1-1, “Non-roaming architecture for 5G Core Network with untrusted non-3GPP access.”

FIG. 7 provides a more detailed view of the untrusted non-3GPP access aspects of FIG. 6. The untrusted non-3GPP access network 604 in FIG. 6 corresponds to the untrusted non-3GPP access 704 in FIG. 7, both representing the non-3GPP networks that provide connectivity to the UE. The non-3GPP interworking function 608 in FIG. 6 is equivalent to the non-3GPP Interworking Function (N3IWF) 702 in FIG. 7, serving as the intermediary between the untrusted non-3GPP access and the core network. The 3GPP core 614 in FIG. 6 is represented in more detail in FIG. 7, showing specific components such as the Access & Mobility Management Function (AMF) 112 and the User plane Function (UPF) 118. The UE 602 in FIG. 6 is analogous to the UE 102 in FIG. 7, representing the end-user device connecting to the network. The data network 610 in FIG. 6 corresponds to the data network 130 in FIG. 7, illustrating the final destination for user data traffic. This correlation between FIG. 6 and FIG. 7 provides a comprehensive view of how the UE transitions between different untrusted non-3GPP access points while maintaining connectivity to the core network.

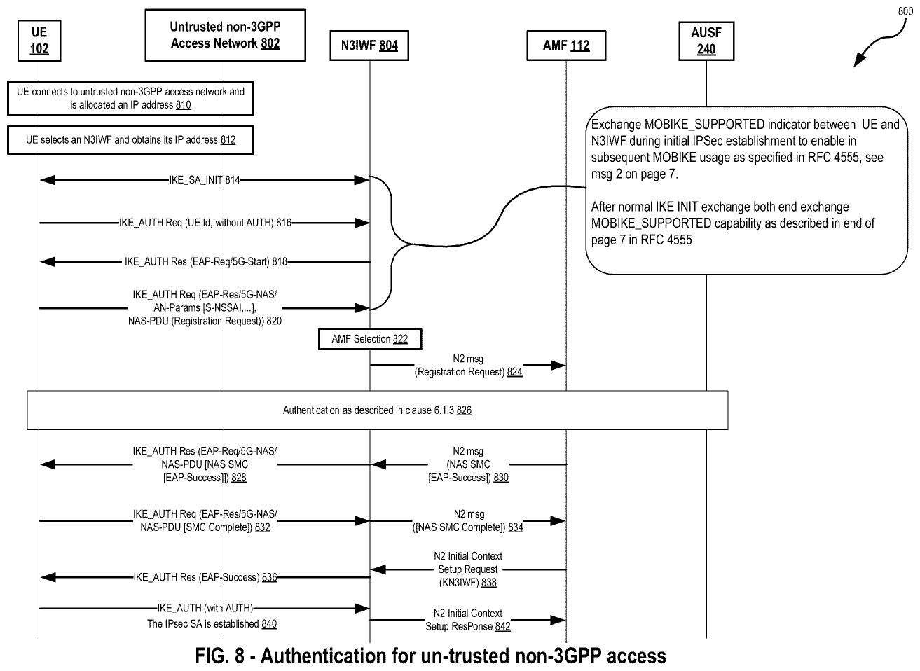

FIG. 8 shows a sequence diagram illustrating the authentication process for untrusted non-3GPP access in a 5G network. The authentication system 800 involves interactions between the User Equipment (UE) 102, Untrusted non-3GPP Access Network 802 (similar to Untrusted non-3GPP Access Network 604), N3IWF 804 (similar to N3IWF 608), AMF 112, and AUSF 240.

The process begins with step 810, where the UE 102 connects to the untrusted non-3GPP access network 802 and is allocated an IP address. In step 812, the UE 102 selects an N3IWF and obtains its IP address.

Step 814 initiates an IKE_SA_INIT exchange between the UE 102 and N3IWF 804. This is followed by step 816, where the UE 102 sends an IKE_AUTH Request to the N3IWF 804, which includes the UE ID but without authentication. In step 818, the N3IWF 804 responds with an IKE_AUTH Response containing an EAP-Request/5G-Start message. Step 820 involves the UE 102 sending another IKE_AUTH Request, this time including EAP-Response/5G-NAS message, which contains NAS parameters and a NAS-PDU Registration Request.

In some aspects, the IKE_SA_INIT exchange initiated in step 814-820 may include the exchange of MOBIKE_SUPPORTED indicators between the UE 102 and N3IWF 804. This exchange may occur during the initial IPSec establishment to enable subsequent MOBIKE usage as specified in RFC 4555.

After the normal IKE_SA_INIT exchange, both the UE 102 and N3IWF 804 may exchange MOBIKE_SUPPORTED capability information. This exchange may be implemented as described at the end of page 7 in RFC 4555. Specifically, the initiator (in this case, the UE 102) may include a MOBIKE_SUPPORTED notification in its IKE_AUTH request message. If the responder (N3IWF 804) also supports MOBIKE and is willing to use it, it may include a MOBIKE_SUPPORTED notification in its response message.

In some cases, the MOBIKE_SUPPORTED notification may be a status notification that does not require any additional data. Its presence in the IKE_AUTH messages may indicate that the sender supports MOBIKE extensions and is prepared to process MOBIKE payload types.

The exchange of MOBIKE_SUPPORTED indicators may allow both the UE 102 and N3IWF 804 to be aware of each other's MOBIKE capabilities from the beginning of their IPSec session. This awareness may facilitate more efficient handling of IP address changes and mobility events in the future.

In some implementations, after the exchange of MOBIKE_SUPPORTED indicators, the authentication process may proceed as previously described. The UE 102 may send an IKE_AUTH Request including the EAP-Response/5G-NAS message, which contains NAS parameters and a NAS-PDU Registration Request, as outlined in step 820.

By incorporating MOBIKE support at this early stage of the connection establishment, the system may be better prepared to handle future mobility events without requiring full re-authentication or re-establishment of security associations. This approach may contribute to reduced latency and improved user experience during handovers or IP address changes in untrusted non-3GPP access scenarios.

The N3IWF 804 then performs AMF selection in step 822 and forwards a N2 Registration Request message to the selected AMF 112 in step 824. Step 826 involves an authentication process as described in clause 6.1.3. In step 828, the N3IWF 804 forwards a NAS SMC to the UE 102 in an IKE_AUTH Response, while in step 830, the AMF 112 sends a N2 NAS SMC message to the N3IWF 804.

Steps 832 and 834 involve the UE 102 responding with an IKE_AUTH Request containing the NAS SMC Complete message, which the N3IWF 804 forwards to the AMF 112. In step 836, the N3IWF 804 sends an IKE_AUTH Response with EAP-Success to the UE 102, prompted by step 838 where the AMF 112 sends a N2 Initial Context Setup Request to the N3IWF 804.

The process concludes with step 840, where an IKE_AUTH message is exchanged between UE 102 and the N3IWF 804 with AUTH payload, establishing the IPsec SA, and step 842, where the N3IWF 804 sends a N2 Initial Context Setup Response to the AMF 112.

In some aspects, a MOBIKE_SUPPORTED indicator may be exchanged between the UE 102 and N3IWF 804 during the initial IPSec establishment. This may enable subsequent MOBIKE usage as specified in RFC 4555, which allows for IP mobility within the IPsec tunnel.

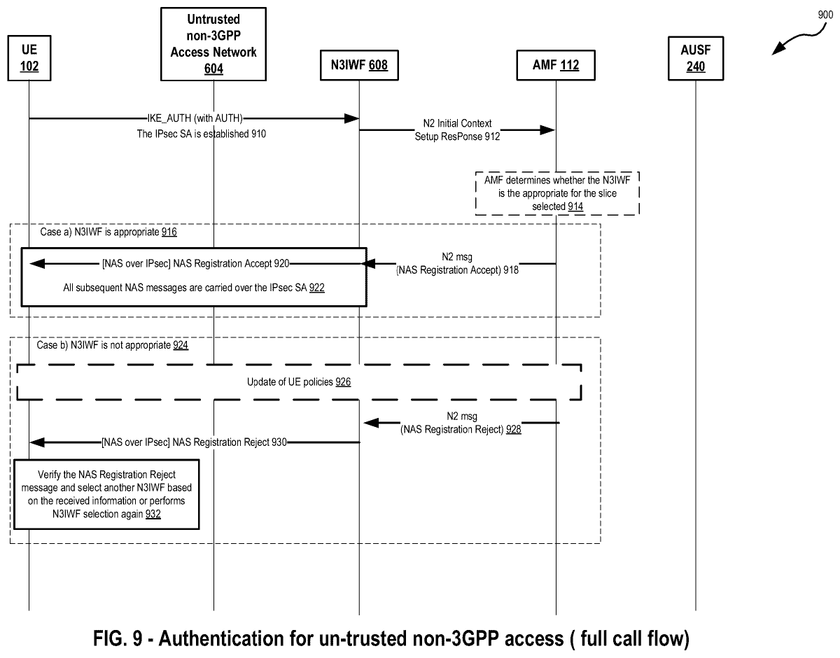

FIG. 9 shows a continuation of the sequence diagram 800 illustrating the authentication process for untrusted non-3GPP access in a 5G network. The authentication flow 900 involves interactions between the User Equipment (UE) 102, Untrusted non-3GPP Access Network 604, N3IWF 804, AMF 112, and AUSF 240.

The process begins with step 910, where the UE 102 sends an IKE_AUTH message with AUTH payload to the N3IWF 804, establishing the IPsec SA. In step 912, the N3IWF 804 sends an N2 Initial Context Setup Response to the AMF 112.

Step 914 involves the AMF 112 determining whether the N3IWF is appropriate for the selected network slice. This decision point leads to two possible scenarios:

In Case a), represented by step 916, the N3IWF is deemed appropriate. In step 918, the AMF 112 sends an N2 message (NAS Registration Accept) to the N3IWF 804. The N3IWF 804 then forwards this as a NAS over IPsec NAS Registration Accept message to the UE 102 in step 920. The process completes with step 922, which indicates that all subsequent NAS messages are carried over the IPsec SA.

In Case b), represented by step 924, the N3IWF is not deemed appropriate. This scenario begins with step 926, where the AMF 112 initiates an update of UE policies. In step 928, the AMF 112 sends an N2 message (NAS Registration Reject) to the N3IWF 804. The N3IWF 804 then forwards this as a NAS over IPsec NAS Registration Reject message to the UE 102 in step 930.

The process concludes with step 932, where the UE 102, upon receiving the NAS Registration Reject message, verifies the message and selects another N3IWF based on the received information or performs N3IWF selection again.

This continuation of the authentication process ensures that the UE 102 is connected to an appropriate N3IWF for the selected network slice, allowing for optimal network performance and resource allocation.

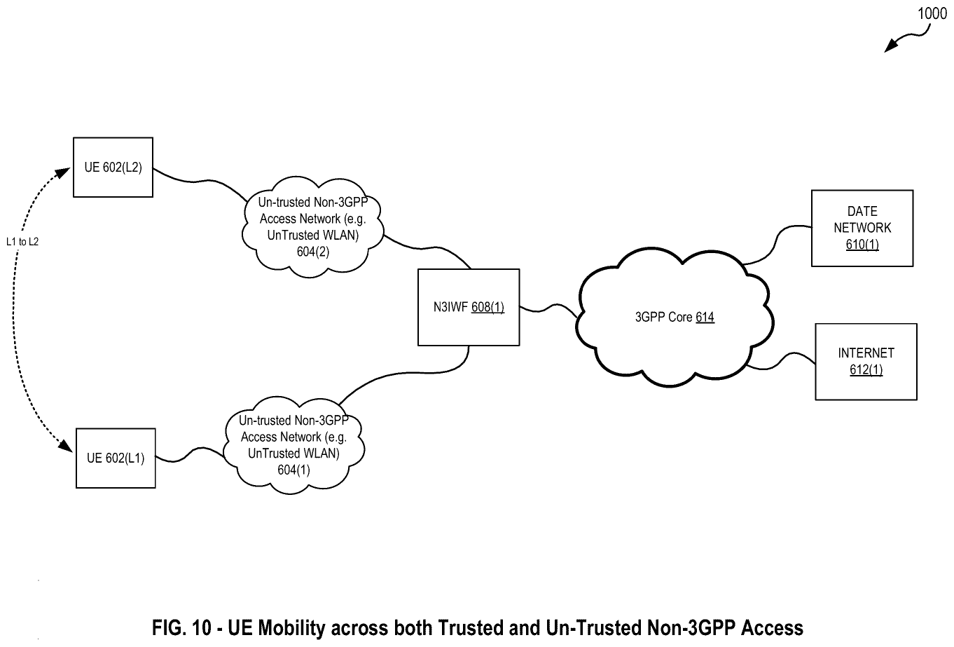

FIG. 10 shows a block diagram of a communication system 1000 for UE mobility across untrusted non-3GPP access networks. The system 1000 includes user equipment 602, untrusted non-3GPP access network 604, non-3GPP interworking function 608, data network 610, internet 612, and 3GPP core 614. The user equipment 602 is shown in two positions, labeled as UE 602(L1) and UE 602(L2), indicating mobility between different access points. Both instances of user equipment 602 are connected to separate untrusted non-3GPP access networks 604, labeled as 604(1) and 604(2) respectively. These untrusted non-3GPP access networks 604 are described as untrusted WLAN networks in the diagram.

To move from the first untrusted non-3GPP Access Network 604(1) to the second untrusted non-3GPP Access Network 604(2), the user equipment 602 may perform several steps. The UE 602 detects a loss of connection or a need to change its point of attachment from 604(1) to 604(2) and establishes a new connection with the second untrusted non-3GPP Access Network 604(2). The UE 602 may acquire a new IP address from 604(2) through a DHCP process. Upon detecting the change in its IP address, the UE 602 prepares to update its connection with the non-3GPP interworking function 608(1). The UE 602 may use MOBIKE protocol to update its existing IPSec security associations with the N3IWF 608(1), reflecting the new IP address acquired from 604(2). The N3IWF 608(1) processes the updated IP address information and associates it with the UE's existing security context. The UE 602 and N3IWF 608(1) may perform a lightweight re-authentication process to verify the UE's identity in its new location. Once the security associations are updated and verified, the UE 602 can resume its data communication through the new untrusted non-3GPP Access Network 604(2) via the same N3IWF 608(1).

This process allows the user equipment 602 to maintain connectivity as it moves between different untrusted non-3GPP access points while minimizing the need for full re-authentication and reducing latency. Unlike trusted non-3GPP access, an Operator is unlikely to have control over one or both of the serving and target APs for the UE. As such these two may fall in two different administrative domains. In addition, the UE is likely to get a new local IP address due to both APs may falling into different administrative domains. The present systems and methods for IPSec optimization is beneficial under this scenario and solves previous latency issues due to reconnect and reauthorization.

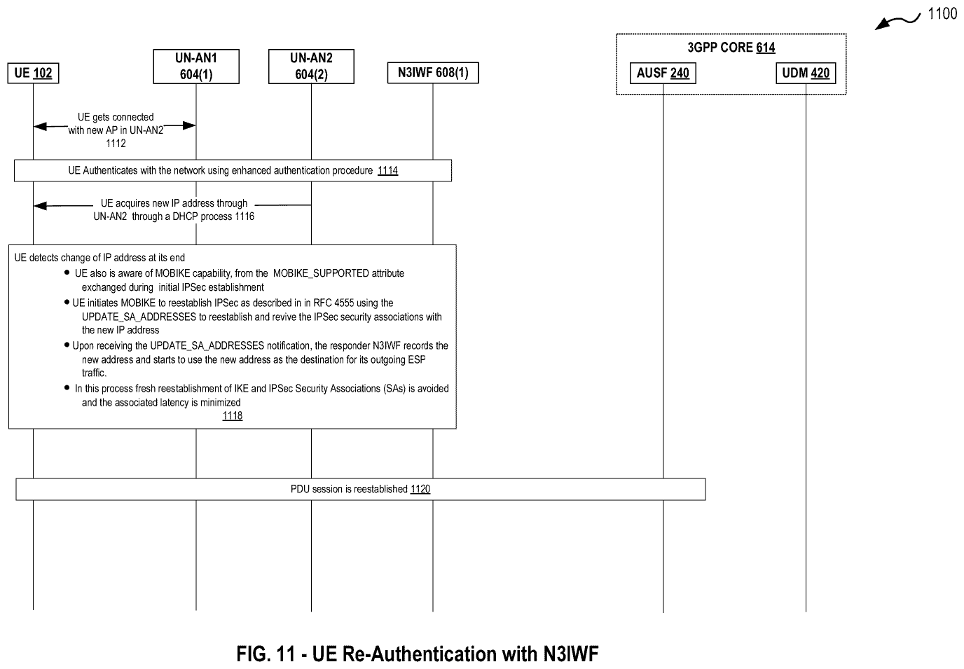

FIG. 11 shows a communication sequence diagram 1100 illustrating the UE Re-Authentication process with N3IWF in the system 1000 depicted in FIG. 10. The diagram presents interactions between six entities: UE 102, UN-AN1 604(1), UN-AN2 604(2), N3IWF 608(1), AUSF 240, and UDM 420, which are part of the 3GPP Core 614. The process begins with step 1112, where the UE 102 gets connected with a new AP in UN-AN2 604(2). This connection triggers the next step, 1114, where the UE authenticates with the network using an enhanced authentication procedure. This authentication process involves communication between the UE 102, UN-AN2 604(2), and N3IWF 608(1). Following authentication, in step 1116, UE 102 acquires a new IP address through UN-AN2 604(2) via a DHCP process. This step is crucial for establishing the UE's new network identity.

Step 1118 is a detailed process where UE 102 detects the change of IP address at its end. This step involves several sub-processes: UE 102 becomes aware of its MOBIKE capability from the MOBIKE_SUPPORTED attribute exchanged during the initial IPSec establishment. UE 102 initiates MOBIKE to reestablish IPSec as described in RFC 4555, using the UPDATE_SA_ADDRESSES to reestablish and revive the IPSec security associations with the new IP address. Upon receiving the UPDATE_SA_ADDRESSES notification, the responder Non-3GPP Inter Working Function (N3IWF) 608(1) records the new address and starts to use it as the destination for its outgoing ESP traffic. This process avoids fresh reestablishment of IKE and IPSec Security Associations (SAs), minimizing associated latency. The final step, 1120, shows that the PDU session is reestablished, completing the re-authentication process.

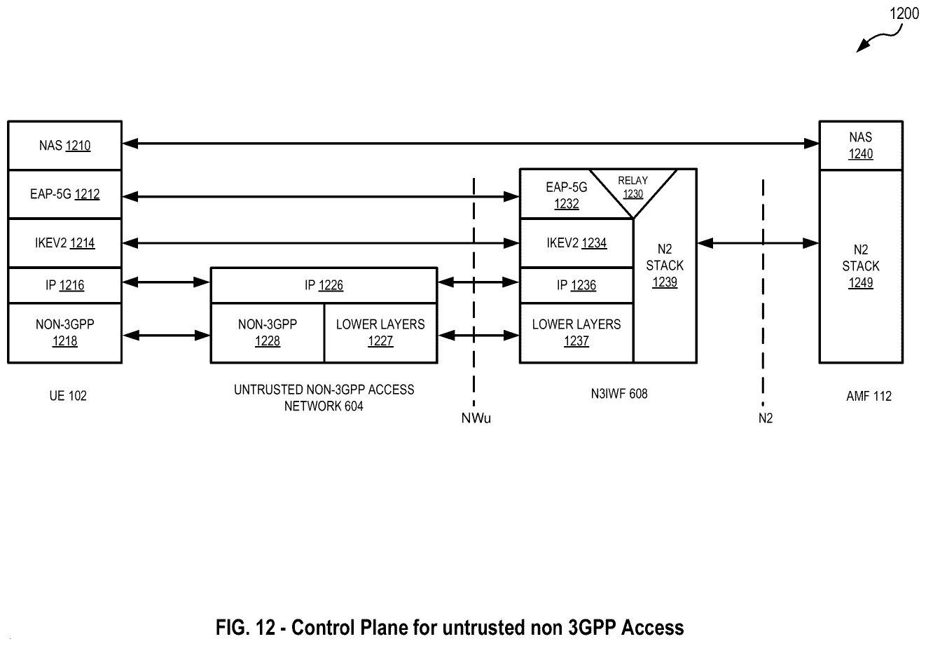

FIG. 12 shows a system diagram 1200 illustrating the control plane architecture for untrusted non-3GPP access in a wireless communication system. The diagram depicts four main components: User Equipment (UE) 102, an untrusted non-3GPP access network 604, a N3IWF 608, and an Access and Mobility Management Function (AMF) 112. Each component is represented with its internal modules and the interfaces connecting them.

The UE 102 is shown with five internal modules: a NAS module 1210, an EAP-5G module 1212, an IKEV2 module 1214, an IP module 1216, and a non-3GPP module 1218. These modules work together to handle various aspects of communication, authentication, and data transfer for the UE 102.

The untrusted non-3GPP access network 604 is depicted with three modules: an IP module 1226, a NON-3GPP module 1228, and a lower layers module 1227. This network acts as an intermediary between the UE 102 and the N3IWF 608, facilitating the initial connection to the 5G core network.

The N3IWF 608 is illustrated with six modules: an EAP-5G module 1232, a relay module 1230, an IKEV2 module 1234, an IP module 1236, a lower layers module 1237, and an N2 stack module 1239. The N3IWF 608 plays a crucial role in bridging the communication between the untrusted non-3GPP access network 604 and the AMF 112, ensuring secure and efficient data transfer.

The AMF 112 is shown with two modules: a NAS module 1240 and an N2 stack module 1249. These modules are responsible for managing network access and facilitating communication with the N3IWF 608.

The diagram illustrates the connections between these components, with the UE 102 communicating with the untrusted non-3GPP access network 604 through IP and Non-3GPP modules. The untrusted non-3GPP access network 604 connects to the N3IWF 608 via an NWu interface, while the N3IWF 608 communicates with the AMF 112 through an N2 interface.

It is important to note that this diagram represents the control plane configuration before the establishment of the signaling IPsec Security Association (SA) between the UE 102 and N3IWF 608. The architecture depicted in this figure enables secure and efficient communication between the UE and the 5G core network through an untrusted non-3GPP access network.

In the context of FIG. 12, the present invention enhances the control plane architecture for untrusted non-3GPP access by incorporating MOBIKE functionality. This enhancement occurs in two main phases: the initialization of the MOBIKE process and its use when a UE switches between untrusted non-3GPP access networks.

During the initialization phase, the IKEV2 module 1214 in the UE 102 and the IKEV2 module 1234 in the N3IWF 608 exchange MOBIKE_SUPPORTED indicators as part of their initial IKE_AUTH messages. This exchange signals that both entities are capable of supporting MOBIKE. For MOBIKE to be leveraged both UE and N3IWF need to support MOBIKE functionality. That is, if MOBIKE is supported by both, then both the UE and the N3IWF 608 store the MOBIKE support information for future use. If one of the UE and the N3IWF does not support MOBIKE functionality for any reason, then MOBIKE feature will simply not be exercised, enabling backwards compatibility without the need for changes to non-MOBIKE devices, such as, for example, or one or both of non-MOBIKE capable UEs and N3IWFs. Reasons for not supporting MOBIKE functionality may include but are not limited to device capability and/or policy. The NAS module 1210 in the UE and the NAS module 1240 in the N3IWF may also have access to this MOBIKE capability to optimize future mobility procedures.

When the UE 102 switches from a first untrusted non-3GPP access network to a second one, the MOBIKE process is utilized as follows: The Non-3GPP module 1218 in the UE detects the change in the access network. The IP module 1216 in the UE then acquires a new IP address from the second untrusted non-3GPP access network. Aware of the MOBIKE support, the IKEV2 module 1214 in the UE initiates the UPDATE_SA_ADDRESSES procedure, for example, as described in sec 2.2 in RFC 4555, to reestablish and revive the previous established IPSec connection and IPSec security associations with the new IP address. The IP module 1216 sends this UPDATE_SA_ADDRESSES message through the new untrusted non-3GPP access network to the N3IWF 608. Upon receiving this message, the IP module 1236 in the N3IWF forwards it to the IKEV2 module 1234 for processing. The IKEV2 module 1234 updates IPSec connection and the IPSec security associations with the UE's new IP address, and the IP module 1236 starts using this new address for traffic with the UE. In this process fresh reestablishment of IKE and IPSec Security Associations (SAs) is avoided and the associated latency is minimized.

This MOBIKE-enhanced process enables a seamless transition between untrusted non-3GPP access networks without requiring full re-authentication or re-establishment of security associations. As a result, it significantly reduces latency and improves the user experience during mobility events in the context of the control plane architecture depicted in FIG. 12.

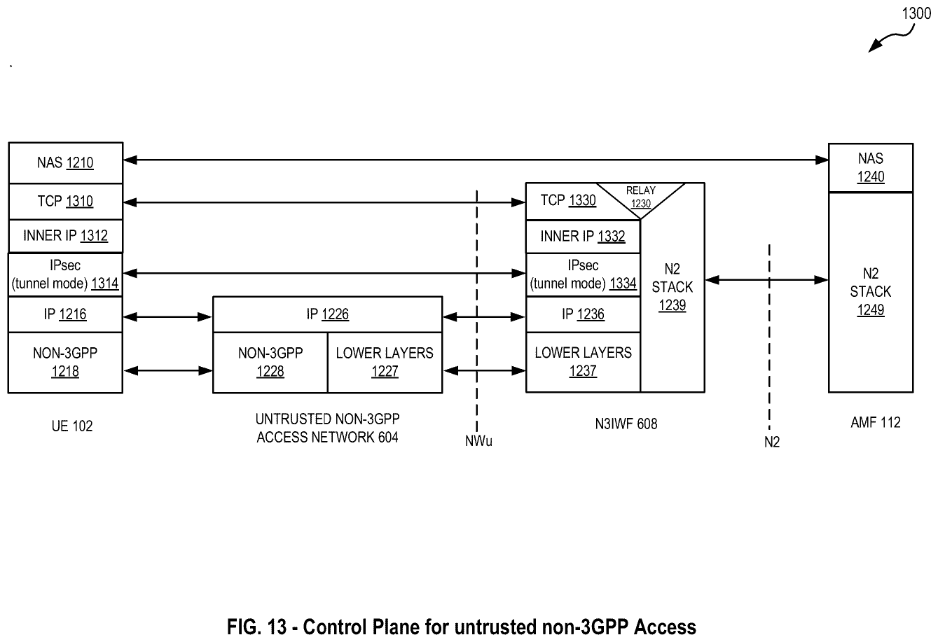

FIG. 13 illustrates a control plane system 1300 for untrusted non-3GPP access in a wireless communication network. The system is shown to include four main components: User Equipment (UE) 102, an untrusted non-3GPP access network 604, a non-3GPP interworking function (N3IWF) 608, and an Access & Mobility Management Function (AMF) 112. These components work together to facilitate secure communication between the UE and the core network through an untrusted non-3GPP access.

Similar to FIG. 12, FIG. 13 depicts the control plane architecture for untrusted non-3GPP access. However, FIG. 13 shows the system after the signaling IPsec SA is established between the UE 102 and N3IWF 608, whereas FIG. 12 illustrates the system before this establishment. As a result, FIG. 13 includes additional modules such as a UE TCP 1310, a UE inner IP 1312, a UE IPsec (in tunnel mode) 1314, an N3IWF TCP 1330, an N3IWF inner IP 1332, and an N3IWF IPsec (in tunnel mode) 1334, which are not present in FIG. 12.

This MOBIKE-enhanced process allows the UE IPsec tunnel 1314 and the N3IWF IPsec tunnel 1334 to be maintained and updated without full re-establishment, even as the UE moves between different untrusted non-3GPP access networks. The inner IP addresses and security associations remain constant, while only the outer IP address of the tunnel is updated. This approach significantly reduces latency and maintains session continuity during mobility events, as the IPsec tunnels do not need to be torn down and re-established.

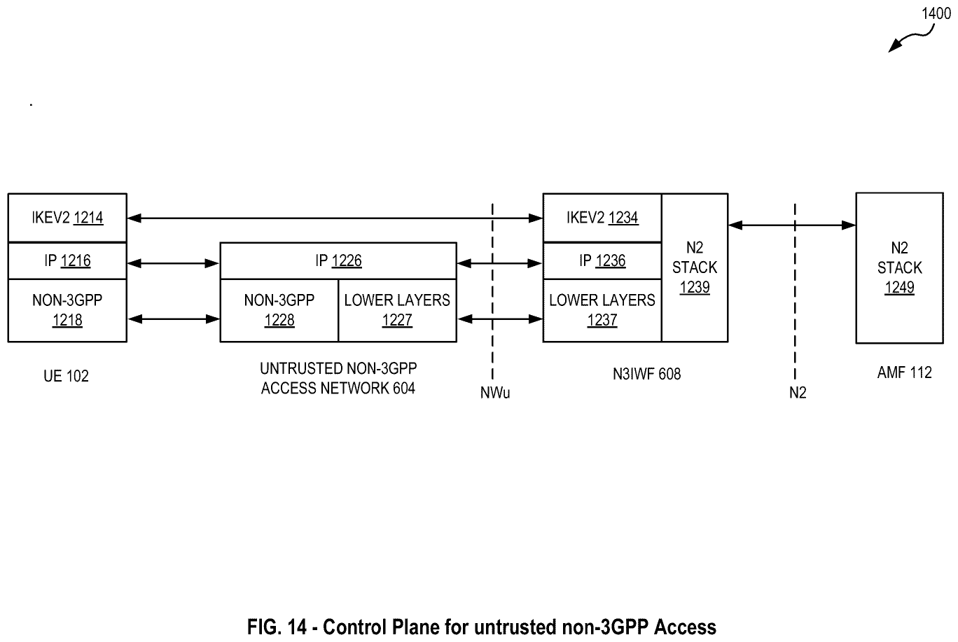

FIG. 14 illustrates a system diagram 1400 of a control plane for untrusted non-3GPP access in a wireless communication system, specifically focusing on the establishment of user-plane via N3IWF. The system is shown to include four main components: User Equipment (UE) 102, an untrusted non-3GPP access network 604, a non-3GPP interworking function (N3IWF) 608, and an Access & Mobility Management Function (AMF) 112.

In the context of FIG. 14, the present invention enhances the control plane for establishing user-plane connections via N3IWF by incorporating MOBIKE functionality. This enhancement is particularly relevant to the IKEV2 modules (1214 in UE and 1234 in N3IWF) and the IP modules (1216 in UE and 1236 in N3IWF).

During the initial establishment, the IKEV2 module 1214 in the UE 102 and the IKEV2 module 1234 in the N3IWF 608 exchange MOBIKE_SUPPORTED indicators as part of their IKE_AUTH messages.

The MOBIKE support information is stored for future use. This allows for efficient handling of IP address changes that may occur during data transmission, without disrupting the established security associations.

When the UE 102 needs to change its point of attachment or IP address while maintaining the connection, the MOBIKE process is utilized as follows: The non-3GPP module 1218 in the UE detects the change, and the IP module 1216 acquires a new IP address. The IKEV2 module 1214, aware of the MOBIKE support, initiates the UPDATE_SA_ADDRESSES procedure.

This UPDATE_SA_ADDRESSES message is sent through the new point of attachment in the untrusted non-3GPP access network 604 to the N3IWF 608. The IKEV2 module 1234 in the N3IWF processes this message, updating the security associations with the UE's new IP address. The IP module 1236 then starts using this new address for outgoing user-plane traffic to the UE.

By incorporating MOBIKE in this manner, the system can maintain the established user-plane connection via the N3IWF even when the UE changes its IP address or point of attachment. This approach significantly reduces the need for re-establishing the entire user-plane connection, thereby minimizing latency and improving the user experience during mobility events or IP address changes.

Furthermore, this MOBIKE-enhanced process allows for a more efficient use of network resources, as it avoids the need for the N3IWF 608 to signal the AMF 112 (via the N2 stack module 1239) for every IP address change, as long as the security associations can be updated using MOBIKE.

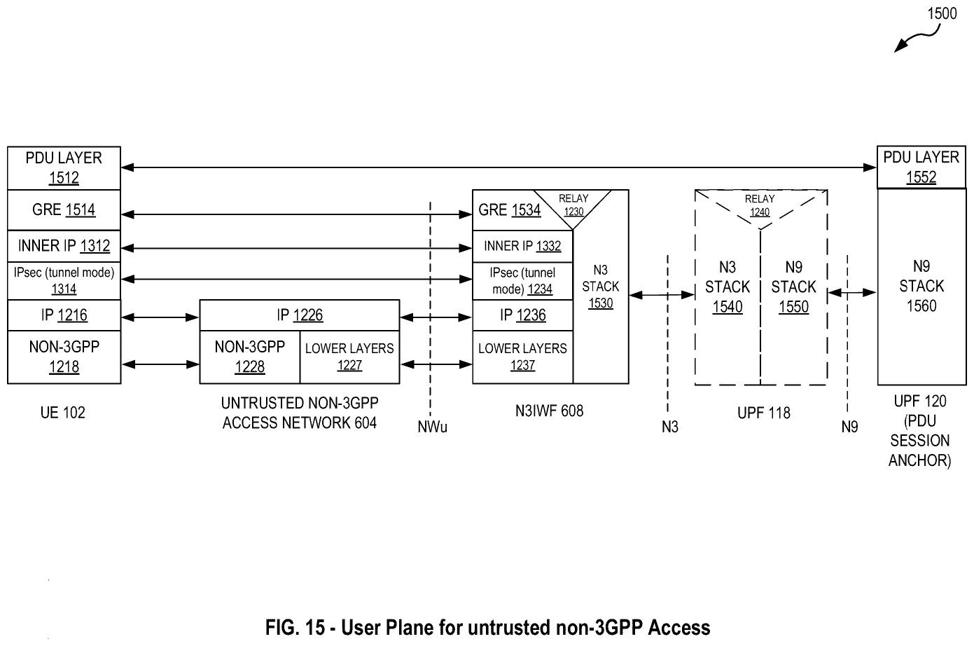

FIG. 15 illustrates a system diagram 1500 of a user plane for untrusted non-3GPP access in a wireless communication network. The system is shown to include several interconnected components to facilitate communication between a User Equipment (UE) 102 and a UPF PDU session anchor 120, representing the user plane path via N3IWF as described in 3GPP TS 23.501 FIG. 8.3.2-1.

In the context of FIG. 15, the present invention enhances the user plane architecture for untrusted non-3GPP access by incorporating MOBIKE functionality, particularly in the IPsec tunnel established between the UE 102 and the N3IWF 608. This enhancement allows for seamless mobility and IP address changes without disrupting the user plane connection.

The user plane path begins at the UE 102, where the PDU layer 1512 generates the user data. This data is then encapsulated by the GRE 1514 and passed through the UE inner IP 1312. The UE IPsec tunnel 1314 provides secure transmission of this data over the untrusted non-3GPP access network 604.

When the UE 102 changes its point of attachment or IP address, the MOBIKE process allows for updating the outer IP address of the IPsec tunnel without affecting the inner IP addressing or security associations. This is crucial for maintaining the user plane connection without interruption.

The N3IWF 608 receives the encrypted data via its IPsec tunnel 1334 and processes it through the N3IWF inner IP 1332. The data is then encapsulated again using GRE 1534 and sent via the N3 stack 1530 to the User Plane Function (UPF) 118.

The UPF 118 acts as an intermediary, processing the data through its N3 stack 1540 and N9 stack 1550 before forwarding it to the UPF PDU session anchor 120 via N9 stack 1560. The UPF PDU session anchor 120 then processes the data at its PDU layer 1552 for final transmission.

By incorporating MOBIKE in this user plane architecture, the system can maintain the established data path even when the UE changes its IP address or point of attachment. This approach significantly reduces the need for re-establishing the entire user plane connection, thereby minimizing latency and improving the user experience during mobility events.

Furthermore, this MOBIKE-enhanced process allows for more efficient use of network resources, as it avoids the need for the N3IWF 608 to signal changes in the user plane path to the core network elements for every IP address change, as long as the security associations can be updated using MOBIKE.

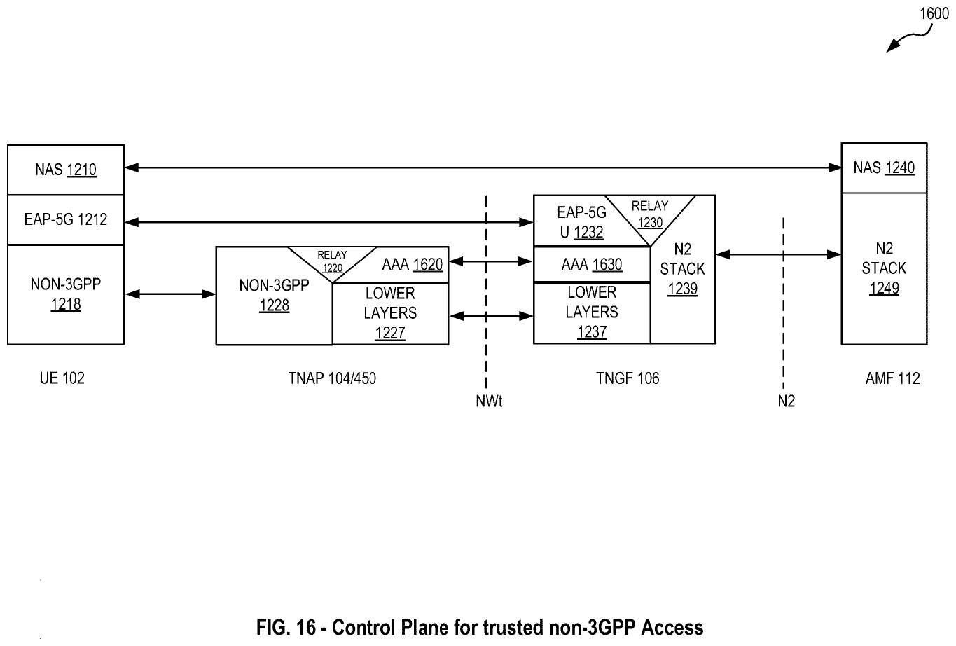

FIG. 16 illustrates a system diagram 1600 of a control plane for trusted non-3GPP access in a wireless communication system. The system is shown to include four main components: User Equipment (UE) 102, a Trusted Non-3GPP Access Point (TNAP) 104/450, a Trusted Non-3GPP Gateway Function (TNGF) 106, and an Access and Mobility Management Function (AMF) 112. This diagram represents the control plane before the NWt connection is established between the UE and TNGF, as specified in FIG. 8.2.5-1 of 3GPP TS 23.501 V19.0.0.

In the context of FIG. 16, the present invention enhances the control plane architecture for trusted non-3GPP access by incorporating MOBIKE functionality during the initial connection establishment phase. This enhancement primarily involves the UE 102, TNAP 104/450, and TNGF 106 components.

The process begins with the UE 102 initiating communication with the TNAP 104/450. The NAS module 1210 in the UE prepares the initial connection request, which is then processed by the EAP-5G module 1212. This module encapsulates the NAS message within an EAP-5G container. The NON-3GPP module 1218 in the UE handles the transmission of this message to the TNAP 104/450.

Upon receiving the message, the NON-3GPP module 1228 in the TNAP 104/450 forwards it to the relay module 1220. The relay module 1220 then passes the message to the AAA module 1620, which is responsible for forwarding the EAP-5G message to the AAA 1630 of the TNGF 106 via the Ta interface.

In the TNGF 106, the AAA module 1630 receives the message and forwards it to the relay module 1230. The EAP-5G module 1232 in the TNGF extracts the NAS message from the EAP-5G container and passes it to the NAS module 1240. At this point, the TNGF 106 may include a MOBIKE_SUPPORTED indicator in its response, signaling its capability to support MOBIKE for future mobility events.

The NAS module 1240 in the TNGF processes the NAS message and prepares a response, which is then sent back to the UE 102. This response may include the MOBIKE_SUPPORTED indicator, allowing the UE to store this information for future use.

By incorporating MOBIKE support at this early stage of the connection establishment, the system prepares for efficient handling of future mobility events. This approach allows for seamless transitions between different TNAPs without requiring full re-authentication or re-establishment of security associations once the NWt connection is established.

The N2 stack module 1239 in the TNGF and the N2 stack module 1249 in the AMF 112 facilitate the exchange of control plane information between the TNGF and the core network, ensuring that the AMF is aware of the UE's connection status and MOBIKE capabilities.

This enhanced control plane architecture sets the foundation for optimized mobility management in trusted non-3GPP access scenarios, potentially reducing latency and improving user experience during subsequent mobility events.

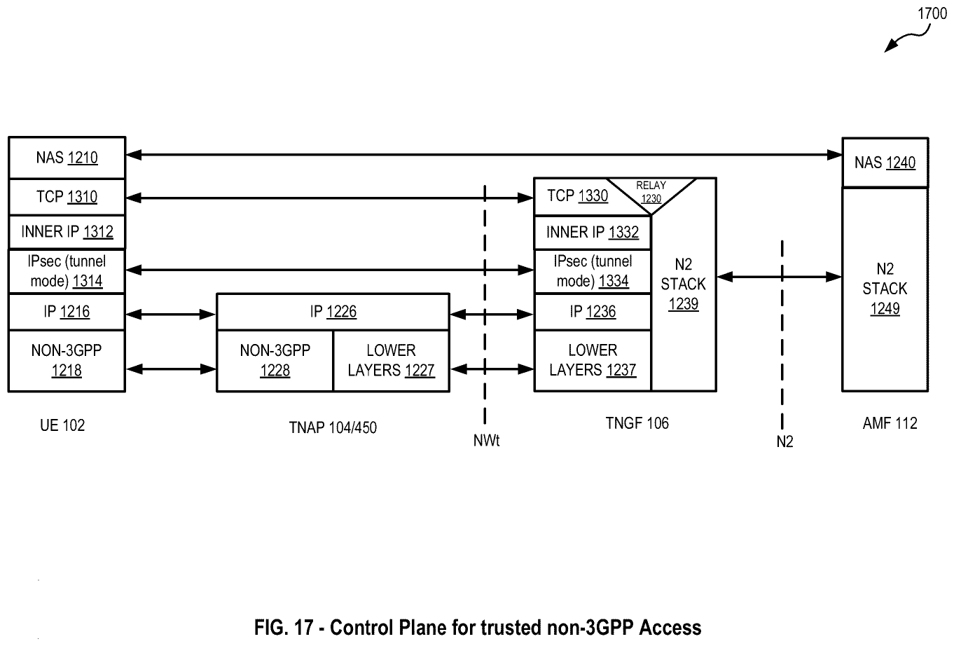

FIG. 17 illustrates a control plane system 1700 for trusted non-3GPP access in a wireless communication network. The system is shown to include User Equipment (UE) 102, a Trusted Non-3GPP Access Point (TNAP) 104/450, a Trusted Non-3GPP Gateway Function (TNGF) 106, and an Access and Mobility Management Function (AMF) 112. This configuration represents the control plane after the NWt connection is established between the UE and TNGF, as specified in FIG. 8.2.5-2 of 3GPP TS 23.501 V19.0.0.

In some aspects, the present invention enhances the control plane architecture by incorporating MOBIKE functionality after the NWt connection is established. This enhancement may primarily involve the UE IPsec tunnel 1314 and the N3IWF IPsec tunnel 1334, which represent the secure NWt connection between the UE 102 and the TNGF 106. The UDP protocol may be used between the UE and TNGF to enable NAT traversal for IKEv2 and IPsec traffic, allowing the system to function effectively even when Network Address Translation (NAT) is present in the network path. The NWt connection, as defined in clause 4.2.8.3 and clause 4.12a.2.2of TS 23.502, may provide a secure tunnel for communication between the UE and the TNGF.

In some cases, after the NWt connection is established, the MOBIKE process can be utilized to maintain the connection during mobility events. When the UE 102 changes its point of attachment or IP address, the non-3GPP module 1218 in the UE may detect the change in the network attachment. The IP module 1216 may then acquire a new IP address from the new TNAP. The UE TCP 1310 and UE inner IP 1312 modules, aware of the MOBIKE support, may initiate the UPDATE_SA_ADDRESSES procedure within the existing UE IPsec tunnel 1314.

The UE IPsec tunnel 1314 may encapsulate the UPDATE_SA_ADDRESSES message using UDP for NAT traversal and send it through the new TNAP to the TNGF 106. The N3IWF IPsec tunnel 1334 in the TNGF may receive and decapsulate this message, forwarding it to the N3IWF TCP 1330 and N3IWF inner IP 1332 modules. These modules may process the UPDATE_SA_ADDRESSES message, updating the security associations within the IPsec tunnel with the UE's new outer IP address. The NAS module 1240 in the TNGF may then inform the AMF 112 of the UE's new location via the N2 stack module 1239, if necessary.

This MOBIKE-enhanced process may allow the IPsec tunnels (UE IPsec tunnel 1314 and N3IWF IPsec tunnel 1334) to be maintained and updated without full re-establishment, even as the UE moves between different TNAPs. The inner IP addresses 1312 and 1332 and security associations may remain constant, while only the outer IP address of the tunnel is updated. By incorporating MOBIKE in this manner, the system can maintain the established NWt connection via the TNGF even when the UE changes its IP address or point of attachment. This approach may significantly reduce the need for re-establishing the entire control plane connection, thereby potentially minimizing latency and improving the user experience during mobility events in trusted non-3GPP access scenarios.

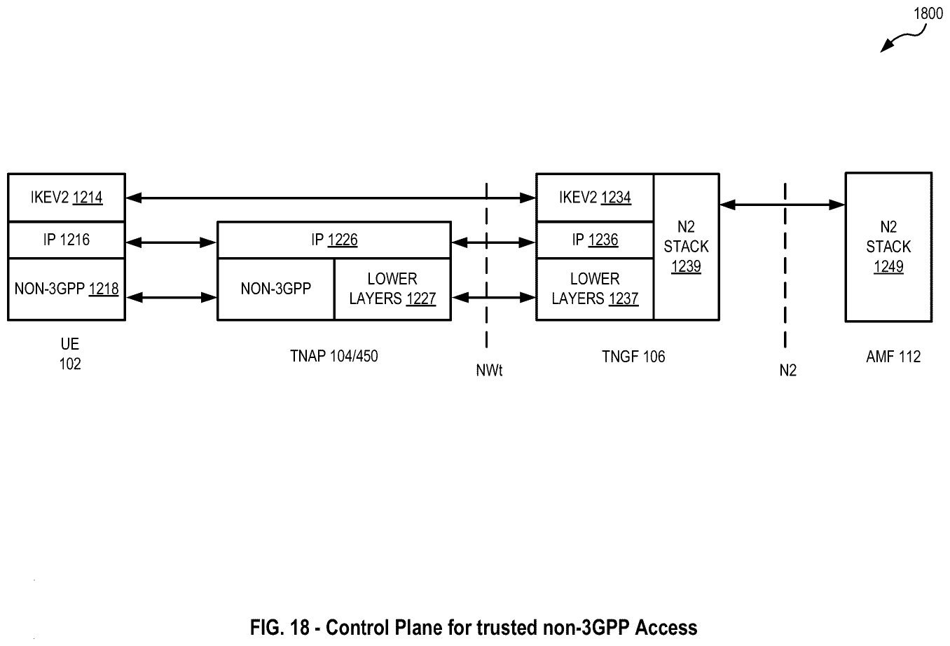

FIG. 18 illustrates a system diagram 1800 of a control plane for trusted non-3GPP access in a wireless communication system. The system is shown to include four main components: User Equipment (UE) 102, a Trusted Non-3GPP Access Point (TNAP) 104/450, a Trusted Non-3GPP Gateway Function (TNGF) 106, and an Access and Mobility Management Function (AMF) 112. This configuration aligns with FIG. 8.2.5-3 of 3GPP TS 23.501 V19.0.0, depicting the control plane for establishment of user-plane via TNGF.

In the context of FIG. 18, the present invention enhances the control plane architecture for establishing user-plane connections via TNGF by incorporating MOBIKE functionality. This enhancement is particularly relevant to the IKEV2 modules (1214 in UE and 1234 in TNGF) and the IP modules (1216 in UE and 1236 in TNGF).

During the initial establishment of the user-plane connection, the IKEV2 module 1214 in the UE 102 and the IKEV2 module 1234 in the TNGF 106 may exchange MOBIKE_SUPPORTED indicators as part of their IKE_AUTH messages. This exchange may occur over the NWt interface, facilitated by the IP modules 1216 and 1236, and the NON-3GPP module 1218 in the UE and the lower layers module 1237 in the TNGF.

The MOBIKE support information may be stored for future use. This allows for efficient handling of IP address changes that may occur during user-plane data transmission, without disrupting the established security associations.

When the UE 102 needs to change its point of attachment or IP address while maintaining the user-plane connection, the MOBIKE process may be utilized as follows: The Non-3GPP module 1218 in the UE may detect the change, and the IP module 1216 may acquire a new IP address. The IKEV2 module 1214, aware of the MOBIKE support, may initiate the UPDATE_SA_ADDRESSES procedure.

This UPDATE_SA_ADDRESSES message may be sent through the new point of attachment in the trusted non-3GPP access network to the TNGF 106. The IKEV2 module 1234 in the TNGF may process this message, updating the security associations with the UE's new IP address. The IP module 1236 may then start using this new address for outgoing user-plane traffic to the UE.

The UDP protocol may be used between the UE and TNGF to enable NAT traversal for IKEv2 and IPsec traffic, as defined in the NWt connection specifications in clause 4.2.8.3 and clause 4.12a.2.2 of TS 23.502. This allows the system to function effectively even when Network Address Translation (NAT) is present in the network path.

By incorporating MOBIKE in this manner, the system can maintain the established user-plane connection via the TNGF even when the UE changes its IP address or point of attachment. This approach may significantly reduce the need for re-establishing the entire user-plane connection, thereby potentially minimizing latency and improving the user experience during mobility events or IP address changes.

Furthermore, this MOBIKE-enhanced process may allow for a more efficient use of network resources, as it may avoid the need for the TNGF 106 to signal the AMF 112 (via the N2 stack module 1239) for every IP address change, as long as the security associations can be updated using MOBIKE.

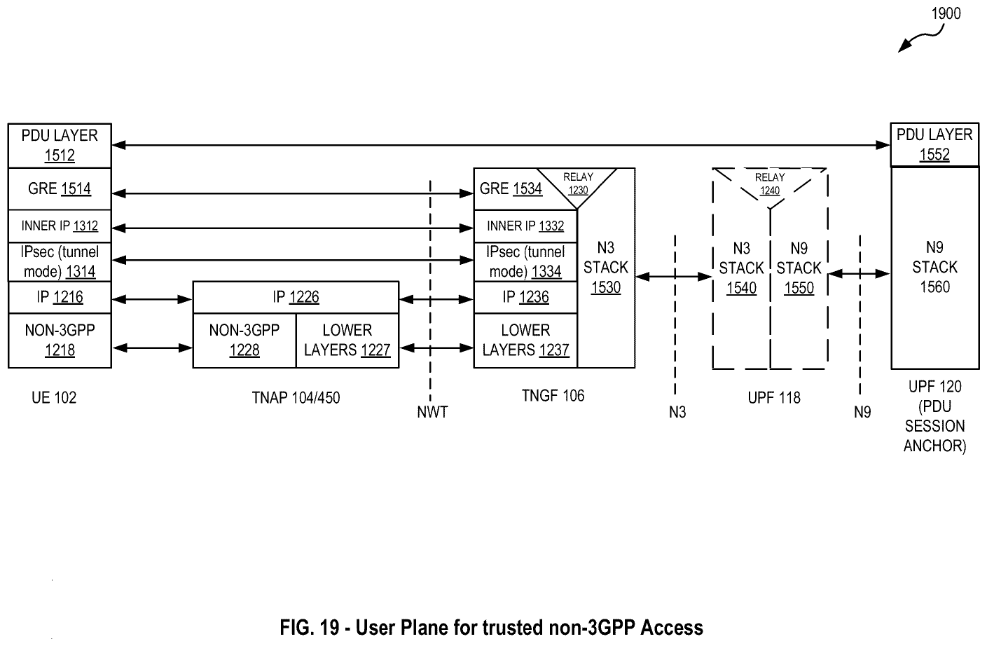

FIG. 19 illustrates a system diagram 1900 of a user plane for trusted non-3GPP access, aligning with FIG. 8.3.2-1 of 3GPP TS 23.501 V19.0.0. The system is shown to include several components interconnected to facilitate communication between a User Equipment (UE) 102 and a User Plane Function (UPF) PDU session anchor 120.

In the context of FIG. 19, the present invention enhances the user plane architecture by incorporating MOBIKE functionality during the initial establishment of the connection between the UE 102 and the Trusted Non-3GPP Gateway Function (TNGF) 106. This enhancement is particularly relevant when there is a need for a device to connect with any gateway function securely using IPSec, and subsequently, this IP connection needs to be re-established for various reasons such as UE mobility, UE changing point of attachment, temporary loss of connectivity, or any other reason.

The MOBIKE functionality may be established during the initial IPSec tunnel setup between the UE IPsec tunnel 1314 and the N3IWF IPsec tunnel 1334. This process may involve the exchange of MOBIKE_SUPPORTED indicators between the UE 102 and TNGF 106 during the IKE_AUTH phase of the initial connection establishment.

When the UE 102 needs to re-establish the connection, instead of performing a full IPSec connection and security association (SA) re-establishment, the system may utilize the previously established MOBIKE functionality. The UE 102 may initiate an UPDATE_SA_ADDRESSES procedure, which can be processed by the TNGF 106 without the need for full re-authentication.

This MOBIKE-enhanced process may allow for efficient handling of various scenarios. For instance, if the UE 102 changes its point of attachment from one Trusted Non-3GPP Access Point (TNAP) 104 to another, the UE may acquire a new IP address via the IP module 1216. The UE inner IP 1312 may then initiate the UPDATE_SA_ADDRESSES procedure within the existing UE IPsec tunnel 1314.

The UPDATE_SA_ADDRESSES message may be encapsulated and sent through the new TNAP to the TNGF 106. The N3IWF IPsec tunnel 1334 in the TNGF may process this message, updating the security associations with the UE's new IP address. This process may occur without disrupting the established PDU session, maintaining the connection through the User Plane Function (UPF) 118 to the UPF PDU session anchor 120.

By incorporating MOBIKE in this manner, the system can minimize latency for end-to-end connectivity during re-establishment scenarios. It may significantly reduce the need for full re-authentication and re-establishment of security associations, thereby potentially decreasing the signaling and processing load for both the UE 102 and the TNGF 106.

Furthermore, this approach may allow for seamless mobility and connectivity maintenance even in cases of temporary loss of connectivity or changes in the UE's point of attachment. The user plane data flow, represented by the path from the PDU layer 1512 in the UE through the various network components to the PDU layer 1552 in the UPF PDU session anchor 120, may be maintained with minimal interruption.

This MOBIKE-enhanced process in the user plane may result in improved efficiency, reduced latency, and enhanced user experience, particularly in scenarios involving frequent mobility or changes in network attachment points in trusted non-3GPP access environments.

A number of implementations have been described. Nevertheless, it will be understood that various modifications may be made without departing from the spirit and scope of the disclosure. Accordingly, other implementations are within the scope of the following claims.

What is claimed is:

1. A method adapted for enabling mobility and multihoming protocol (MOBIKE) support in a non-3GPP (3rd Generation Partnership Project) network gateway function environment, the method comprising:
during a communication with a first non-3GPP access point (NAP) in data communication with an apparatus configured for a network gateway function, initiating an exchange of data between a user equipment (UE) and the apparatus, the exchange of data comprising an exchange of first data indicative of whether the UE supports MOBIKE capability and second data indicative of whether the apparatus supports MOBIKE capability;
utilizing the first and second data to determine whether to enable MOBIKE operations for at least one of the UE or the apparatus, thereby optimizing Internet Protocol Security (IPSec) session re-establishment based on a change in association of the UE from the first NAP to a second NAP in data communication with the apparatus; and
based on the determination, enabling or not enabling the MOBIKE operations for the at least one of the UE or the apparatus.

2. The method of claim 1, wherein:
the first NAP comprises a trusted Non-3GPP Access Point (TNAP); and
the second NAP comprises an untrusted non-3GPP access point (UNAP).

3. The method of claim 1, wherein:
the first NAP comprises an untrusted non-3GPP access point (UNAP); and
the second NAP comprises a trusted Non-3GPP Access Point (TNAP).

4. The method of claim 1, wherein the apparatus comprises a trusted non-3GPP Gateway Function (TNGF).

5. The method of claim 1, wherein the apparatus comprises a non-3GPP interworking function (N3IWF).

6. The method of claim 1, wherein the utilizing of the first and second data to determine whether to enable the MOBIKE operations comprises determining to enable the MOBIKE operations for each of the UE and the apparatus only when the first and second data respectively indicate that both the UE and the apparatus support MOBIKE capability.

7. The method of claim 1, wherein:
the utilizing of the first and second data to determine whether to enable the MOBIKE operations comprises determining to not enable the MOBIKE operations for the at least one of the UE or the apparatus based on the at least one of the first data or the second data indicating that the at least one of the UE or the apparatus does not support the MOBIKE capability, respectively; and
the non-enablement of the MOBIKE operations for the at least one of the UE or the apparatus enables backwards compatibility without a need for changes to the at least one of the UE or the apparatus which does not support MOBIKE capability.

8. The method of claim 1, wherein the utilizing of the first and second data to determine whether to enable the MOBIKE operations comprises utilizing one or more parameters to determine to not enable the MOBIKE operations for the at least one of the UE or the apparatus regardless of the at least one of the first or second data, respectively.

9. The method of claim 8, wherein the one or more parameters comprise at least one of: (i) one or more operational parameters, (ii) one or more policy parameters, or (iii) one or more configuration parameters.

10. The method of claim 1, wherein the first data comprises at least one “MOBIKE_SUPPORT” indicator.

11. The method of claim 1, wherein the exchange of the data is part of an Internet Key Exchange (IKE) protocol initiation (IKE-INIT) communication.

12. A computerized apparatus configured for a network gateway function and configured for data communication with a computerized client device, the computerized apparatus comprising:
processor apparatus;
interface apparatus in data communication with the processor apparatus and configured for data communication with the computerized client device; and
computerized logic in data communication with the processor apparatus and configured to, when executed, cause the computerized apparatus to:
receive first data originating from the computerized client device, the first data indicative of whether the computerized client device is mobility and multihoming protocol (MOBIKE) capable;
generate second data for transmission to the computerized client device, the second data indicative of whether the computerized apparatus is MOBIKE capable; and
determine, based on at least the first and second data, whether to enable one or more MOBIKE operations for at least one of the computerized client device or the computerized apparatus to optimize an Internet Protocol Security (IPSec) session re-establishment for the computerized client device in a handover operation from a first non-3GPP access point (NAP) to a second NAP in data communication with the computerized apparatus.

13. The computerized apparatus of claim 12, wherein the network gateway function comprises one of: (i) a non-3GPP gateway function (NGF), or (ii) a non-3GPP interworking function (N3IWF).

14. The computerized apparatus of claim 12, wherein the receipt of the first communication and the transmission of the second communication are part of an Internet Key Exchange (IKE) protocol initiation (IKE-INIT).

15. The computerized apparatus of claim 12, wherein the determination, based on at least the first and second data, of whether to enable the one or more MOBIKE operations is further based on third data relating to one or more of (i) operational data, (ii) policy data, or (iii) configuration data, such that MOBIKE is enabled based on the first and second data respectively indicating that the computerized client device and the non-3GPP gateway function apparatus are both MOBIKE capable unless at least one of the computerized client device or the non-3GPP gateway function apparatus determines not to enable the one or more MOBIKE operations based on the one or more of (i) the operational data, (ii) the policy data, or (iii) the configuration data.

16. A computerized user device configured to communicate with a network having a plurality of access points and a network gateway function, the computerized user device comprising:
processor apparatus;
an interface apparatus in data communication with the processor apparatus and configured to exchange data with an apparatus configured for the network gateway function; and
computerized logic in data communication with the processor apparatus and configured to, when executed by the processor apparatus, cause the computerized user device to:
detect a move from a range within a first non-3GPP access point (NAP) to range within a second NAP connected to the apparatus; and
based on the detection, initiate a mobility and multihoming protocol (MOBIKE) to update an existing Internet Protocol Security (IPSec) session to reflect a change in a point of attachment to a network;
wherein the MOBIKE is configured to cause a re-establishment, by the apparatus, of the IPSec session with the computerized user device over the second NAP using extant MOBIKE support, thereby maintaining a secure and continuous connection without need for full re-authentication with the second NAP.

17. The computerized user device of claim 16, wherein the computerized logic is further configured to, when executed by the processor apparatus, cause the computerized user device to:
update an IP address of the computerized user device via use of a MOBIKE “UPDATE_SA_ADDRESSES” function to reflect the second NAP point of attachment to the network, wherein the maintenance of the IPSec session continuity is effected via processing of the updated IP address by the apparatus.

18. The computerized user device of claim 16, wherein the detection comprises a measurement of a signal strength to determine a connectivity level to the first NAP has diminished below a threshold level.

19. The computerized user device of claim 16, wherein the initiation of the MOBIKE comprises transmission of a MOBIKE “UPDATE_SA_ADDRESSES” message to the apparatus to inform the apparatus about a new point of attachment.

20. The computerized user device of claim 19, wherein the re-establishment of the IPSec session is based on validation, by the apparatus, of the new point of attachment for the computerized user device.

21. The computerized user device of claim 16, wherein the re-establishment of the IPSec session comprises maintenance of an IPSec Security Association (SA) without creating a new SA for the computerized user device.

22. The computerized user device of claim 16, wherein the computerized logic is further configured to, when executed by the processor apparatus, cause the computerized user device to:
perform a mutual authentication process with the apparatus using existing credentials associated with the IPSec session prior to the re-establishment of the IPsec session.

23. Computer readable apparatus comprising a non-transitory storage medium, the non-transitory storage medium comprising at least one computer program having a plurality of instructions, the plurality of instructions configured to, when executed on a processing apparatus of a computerized client device, cause the computerized client device to:
detect a change of at least one of: (i) a first IP address to a second IP address, (ii) a first access network to a second access network, or (iii) a first point attachment to the first access network to a second point attachment to the second access network;
utilize a mobility and multihoming protocol (MOBIKE) based on at least one attribute exchanged during an initial IPSec session establishment between the computerized client device and an apparatus configured for a network gateway function; and
transmit data representative of a notification to the apparatus to update a security association with respect to at least one of (i) the second IP address, (ii) the second access network, or (iii) the second point attachment;
wherein the data representative of the notification is configured to cause the apparatus to associate the at least one of (i) the second IP address, (ii) the second access network, or (iii) the second point attachment with outgoing encapsulating security payload (ESP) traffic for the UE.

24. The computer readable apparatus of claim 23, wherein latency is reduced in part by eliminating reestablishment at least one of Internet Key Exchange (IKE) and IPSec Security Associations (SAs).

25. The computer readable apparatus of claim 23, wherein the at least one attribute comprises a “MOBIKE_SUPPORTED” attribute indicating MOBIKE compatibility by the computerized client device and a “MOBIKE_SUPPORTED” attribute indicating MOBIKE compatibility by the apparatus.

26. The computer readable apparatus of claim 23, wherein the data representative of the notification comprises a “UPDATE_SA_ADDRESSES” notification.

27. A method for maintaining a secure communication session in a wireless communication network, the method comprising:
establishing, by a user equipment (UE), a first secure communication session with a non-3GPP gateway function (NGF) via a first non-3GPP access point (NAP);
disconnecting, by the UE, from the first NAP and connecting to a second NAP while maintaining the established secure communication session with the NGF;
acquiring, by the UE, a new Internet Protocol (IP) address from the second NAP;
transmitting, by the UE, an update message to the NGF to associate the new IP address with the established secure communication session without re-establishing the secure communication session;
wherein the update message causes the NGF to update security associations to associate the new IP address with a UE's prior secure communication session; and
reusing, by the UE, the secure communication session with the NGF via the second NAP using the new IP address, wherein the secure communication session is maintained without requiring a full re-authentication process.

28. The method of claim 27, further comprising moving a communication link from the first NAP and connecting to the second NAP while maintaining the established secure communication session with the NGF.

29. The method of claim 27, wherein the update message comprises a MOBIKE protocol “UPDATE_SA_ADDRESSES” notification.

30. The method of claim 27, further comprising detecting, by the UE, the disconnection from the first NAP and a subsequent connection to the second NAP.

31. The method of claim 27, wherein the secure communication session comprises an Internet Protocol Security (IPSec) session.

32. The method of claim 31, wherein the IPSec session is maintained by utilizing Mobility and Multihoming Protocol (MOBIKE) support.

33. The method of claim 32, wherein the NGF updates the security associations without interrupting the data flow of the secure communication session.
